(19) United States
(12) Patent Application Publication
(10) Pub. No.: US 2011/0027084 A1
(43) Pub. Date: Feb. 3, 2011

(54) NOVEL TURBINE AND BLADES

(76) Inventor: Andrew Rekret, Toronto (CA)

Correspondence Address: BRINKS HOFER GILSON & LIONE, P.O. BOX 10395, CHICAGO, IL, 60610, US

(21) Appl. No.: 12/846,324

(22) Filed: Jul. 29, 2010

Related U.S. Application Data
(60) Provisional application No. 61/230,425, filed on Jul. 31, 2009.

(51) Int. Cl. F03D 3/02; F03D 3/06; F03D 11/04; F03D 11/02

(52) U.S. Cl. 416/126; 416/176; 416/178; 290/55

(57) ABSTRACT

A variable axis turbine may include multiple nested rotatable rotor assemblies. The turbine may be self-starting in slow fluid conditions while simultaneously self-limiting in fast fluid conditions. The turbine may provide omni-directional energy recovery and be self-balancing. The nested rotatable rotor assemblies may be configured to rotate independently of each other, but along the same rotational axis. Each outer nested rotor blade set may direct fluid onto the inner rotor blade sets in an aerodynamically beneficial manner. Each rotor blade set may be interconnected with a rotating generator hub that encloses a rotating generator element that rotates along with a corresponding rotor blade set for electric power generation. The blades may be “smart blades” that are sufficiently flexible to be self-configuring during rotation and soft enough to partially absorb sound. The blades may have a variable hardness and a two or more dimensional twist.

### RELATED APPLICATIONS

The present application claims the benefit of the filing date under 35 U.S.C. §119 (e) of U.S. Provisional Application Ser. No. 61/230,425, filed on Jul. 31, 2009 and entitled Variable Axis Turbine With Nested Rotor Blade Sets.

### BACKGROUND

The present embodiments relate generally to turbines. More particularly, the present embodiments relate to turbines with multiple blade sets.

Conventional wind turbines include the Darrieus design. A Darrieus-type configuration may include two curved blades whose ends are attached to fixed upper and lower hubs. Darrieus-type designs are disclosed in U.S. Pat. Nos. 1,835,018; 2,020,900; 4,112,311; 4,204,805 and 4,334,823. However, Darrieus-type designs may have inherent deficiencies, including (1) that only the middle one-third of the blade may efficiently create power; (2) that the farther the distance from a curved blade to its axis of rotation, the greater the likelihood of harmonic vibration and self-destruction; (3) needing assistance in starting; (4) using more energy than actually producing in some wind conditions; (5) exhibiting torque fluctuations during each revolution as the blades move into and out of the wind; and (6) difficulties with speed regulation in high wind speeds.

Blades with helical twists were known, such as disclosed by the Gorlov design and the article, Composite Manufacturing Process for Wind Energy, JEC COMPOSITES MAGAZINE, May 2008, at 38-40, which is incorporated herein by reference in its entirety.

Additional conventional turbines include that of U.S. Pat. No. 5,269,647, which discloses a rotor arm having a plurality of loops that rotate as a single assembly. Conventional fan assemblies include that of U.S. Pat. No. 5,760,515, which discloses two blade sets that rotate in opposite directions.

### BRIEF SUMMARY

The scope of the present invention is defined solely by the appended claims, and is not to be construed to any degree by the statements within this summary.

Briefly, the present invention is directed to a turbine. The turbine enhances electrical power generation across a range of very low to high fluid speed based on the synergistic effects of several design features. The turbine may include one or more of the following features: (1) multiple nested rotors each with its own blade set, with each rotor being arranged to independently rotate with a synergistic result; (2) an extremely low cut-in speed; (3) self-limiting functionality in fast fluid conditions; (4) a variable axis design that permits omni-directional energy harvesting; (5) soft, quiet blades; and/or (6) a self-balancing base.

Each rotor may include several blades and multiple hubs in a single assembly. At least one hub may operate an electrical generator. The shape and composition of the blades themselves may provide for “smart blades” that bend, stress, or otherwise re-shape themselves during operation to improve aerodynamic efficiency. Each blade may have a variable hardness, and a non-uniform, concavo-convex cross-sectional area that is a function of blade height.

In one aspect, a turbine is operated by a moving fluid, for example, air or water. The turbine may include a first rotatable rotor assembly having a first set of spaced apart rotatable hubs on opposite sides of the central portion of the first rotatable rotor assembly, and a first set of blades extending between the first set of opposed hubs. The first rotatable rotor assembly may be constructed and arranged for rotation of the first set of blades in a first rotational path. The turbine may include a second rotatable rotor assembly positioned inside the first rotatable rotor assembly and having a second set of spaced apart rotatable hubs on opposite sides of the central portion, and a second set of blades extending between the second set of opposed hubs. The second rotatable rotor assembly may be constructed and arranged for rotation of the second set of blades in a second rotational path located within and sufficiently close to the first rotational path of the first set of blades such that fluid action between the first set of blades and the second set of blades at least partially aids the rotation of the second rotatable rotor assembly. The turbine may include a third rotatable rotor assembly positioned inside the second rotatable rotor assembly and having a third set of spaced apart rotatable hubs on opposite sides of the central portion, and a third set of blades extending between the third set of opposed hubs. The third rotatable rotor assembly may be constructed and arranged for rotation of the third set of blades in a third rotational path located within and sufficiently close to the second rotational path of the second set of blades such that fluid action between the second set of blades and the third set of blades at least partially aids the rotation of the third rotational rotor assembly. The turbine may include at least one electrical generator affixed to and/or driven by one or more of the first, second, and third rotatable rotor assemblies.

In another aspect, a turbine is operated by a moving fluid, such as air or water. The turbine may include a first rotatable rotor assembly having at least one first rotatable hub on at least one side of the central portion of the first rotatable rotor assembly, and a first set of blades extending from the at least one hub. The first rotatable rotor assembly may be constructed and arranged for rotation of the first set of blades in a first rotational path. A second rotatable rotor assembly may be positioned inside the first rotatable rotor assembly and have at least one second rotatable hub on at least one side of the central portion, and a second set of blades extending from the at least one second hub. The second rotatable rotor assembly may be constructed and arranged for rotation of the second set of blades in a second rotational path located within and sufficiently close to the first rotational path of the first set of blades such that fluid action between the first set of blades and the second set of blades at least partially aids the rotation of the second rotatable rotor assembly. The turbine may include a third rotatable assembly positioned inside the second rotatable rotor assembly and have at least one rotatable hub on at least one side of the central portion, and a third set of blades extending from the at least one third hub. The third rotatable rotor assembly may be constructed and arranged for rotation of the third set of blades in a third rotational path located within and sufficiently close to the second rotational path of the second set of blades such that fluid action between the second set of blades and the third set of blades rotates the third rotational rotor assembly. The turbine may include at least one electrical generator operated by one or more of the first, second, and third rotatable rotor assemblies.

In another aspect, a wind turbine operates with a reduced amount of noise caused by the rotating blades. The turbine may include a plurality of blades, with each of the blades having a length and an overall width. The blade lengths may be longer than the blade widths. The blades have leading edges and trailing edges. The leading edges may have rounded cross-sectional profiles. The blades may have a cross-sectional profile that includes the leading edges being positioned more outwardly with respect to the turbine interior than the trailing edges. The blades may have rigid portions adjacent to the leading edges and relatively flexible materials forming the trailing edges. The rigid portions may have reduced hardness moving from the leading edges toward the flexible flaps. The relatively flexible trailing edges may have widths ranging from about 0.1 to about 0.3 times the overall widths of the blades.

In another aspect, a rotatable rotor assembly for a wind turbine may be adapted to be packaged with disassembled parts and later assembled. The assembly may include at least one pair of hubs having a central axis. The hubs may have a plurality of receptacles inclined at acute angles relative to the axis of the hubs and arranged equidistant apart. Each receptacle may be configured to receive (or be received by) one end of a blade. The assembly may include a plurality of blades adapted to be inserted into (or receive) the receptacles and extend between a pair of the hubs.

In still another aspect, a turbine is operated by a moving fluid. The turbine may include a variable axis post. The turbine may include a first rotatable rotor assembly having at least one first hub rotatably mounted on the variable axis post, and a first set of blades may extend from the at least one first hub. The first rotatable rotor assembly may be constructed and arranged for rotation of the first set of blades in a first rotational path. The turbine may include a second rotatable rotor assembly positioned inside the first rotatable rotor assembly and having at least one second hub rotatably mounted on the variable axis post, and a second set of blades may extend from the at least one second hub. The second rotatable rotor assembly may be constructed and arranged for rotation of the second set of blades in a second rotational path located within and sufficiently close to the first rotational path of the first set of blades such that fluid action between the first set of blades and the second set of blades at least partially aids the rotation of the second rotatable rotor assembly. The turbine may include at least one electrical generator driven by one or more of the first and second rotatable rotor assemblies.

Advantages will become more apparent to those skilled in the art from the following description of the preferred embodiments which have been shown and described by way of illustration. As will be realized, the system and method are capable of other and different embodiments, and their details are capable of modification in various respects. Accordingly, the drawings and description are to be regarded as illustrative in nature and not as restrictive.

### BRIEF DESCRIPTION OF THE DRAWINGS

FIG. 1 illustrates an exemplary variable axis turbine with nested and rotatable rotor assemblies;

FIGS. 1a and 1b illustrate different perspectives of the turbine;

FIGS. 1c and 1d illustrate an exemplary self-balancing turbine;

FIG. 2 illustrates an exemplary rotor assembly that is self carpeting;

FIG. 3 illustrates another exemplary rotor blade set;

FIG. 3a illustrates another exemplary blade shape;

FIG. 4 illustrates exemplary rotor assemblies of different length and width such that the rotor assemblies may be nested inside of one another;

FIG. 5 illustrates an exemplary top plan view of a blade;

FIG. 6 illustrates an exemplary side view of a blade;

FIG. 7 illustrates an exemplary rotor blade set having a variable hardness and flexibility;

FIG. 8a is a diagrammatic view of a blade in cross-section showing an attached flexible flap;

FIG. 8b illustrates an exemplary cross-section of a blade in which the flexible flap is integral with the blade;

FIG. 8c is a fragmentary diagrammatic view of an owl-like wing showing the distal portion with serrations;

FIGS. 9a and 9b illustrate exemplary generator hubs;

FIG. 10 illustrates an exemplary rotational path of a blade;

FIG. 11 illustrates one type of generator configuration;

FIG. 12 illustrates one type of generator hub configuration;

FIG. 13 illustrates exemplary integrated computer control;

FIGS. 14 and 15 illustrate exemplary results from wind tunnel testing;

FIG. 16 is a diagrammatic illustration of devices controlling the air-flow, and an alternative configuration of blade design in which the blade is attached to a large disc which may be self-balancing;

FIG. 17 illustrates a cross-sectional blade design of a useful specific air-foil for the blades of the FIG. 18 embodiment;

FIG. 18 is a diagrammatic illustration in horizontal cross-section of another embodiment for achieving an increased drop in the wind pressures across the blades. The relative positions and sizes of the blades in each set are illustrative, but not necessarily typical;

FIG. 19 is an illustration of a wind turbine with a rotor in the shape of a ring or disc for driving a generator located externally of the rotor;

FIG. 20 illustrates a belt gear rack for mounting on the disc rotor of the wind turbine in FIG. 19;

FIG. 21 illustrates an embodiment of a one form of blade configuration containing a reinforcing cable; and

FIGS. 22a, 22b, and 22c show in cross-section views of single stator and dual stator generators.

### DETAILED DESCRIPTION

The following definition should be understood throughout this description and appended claims. A “fluid” refers to either gas or liquid, for example, air or water.

The embodiments described herein include apparatuses, systems, and methods for electric power generation and turbine manufacture. A variable axis turbine is provided that may generate electric power from wind or water. The turbine may include the nesting of multiple rotors, each with its own blade set. Each rotor and blade set may be configured to separately rotate around the same axis of rotation as the other rotors and blade sets. The nesting of multiple rotor blade sets may produce overall rotational energy in excess of the sum of the energy obtainable from the same blade sets operating at distances spaced from each other.

The turbine may be self-starting at very low fluid speed. Each blade may have a two-dimensional twist forming a concavo-convex cross-sectional area. As such, each blade may be shaped to form a curvilinear arc with a concave cavity facing a central interior area of the turbine about which each blade rotates. The interior facing concave surface of each blade may act somewhat like a sail of a boat and be pushed by moving fluid to rotate the blade. The concave surface may facilitate, by itself, or in combination with other blade features, self-starting in slow fluid conditions.

The turbine may be auto-regulating, such as by inherently self-limiting the maximum rotational speed of the blades. The blades may be shaped so that each rotor blade set may accelerate to a point of equilibrium during fast fluid conditions. Once a maximum steady state speed of each rotor blade set is reached, the rotational speed of each rotor blade set may not increase further even as the speed of the moving fluid continues to increase. To facilitate the self-limiting functionality, each blade may have an exterior facing convex surface that is twisted such that at least a portion of the convex surface behaves analogous to an airbrake or the flap of an airplane while landing. The convex surface, by itself or in combination with other blade features, may catch enough of a fast moving fluid to limit the maximum speed of blade rotation.

The blades can be configured for specific weather or temperature conditions, including different types of wind or fluid streams. Each of the blades may be a “smart blade,” such as being made of a sufficiently soft material that permits the blade to flex, bend, compress, and/or otherwise re-shape itself to a more aerodynamic shape during rotation. Each blade may be manufactured to have a variable hardness longitudinally and/or axially. In one embodiment, the blades may be sufficiently flexible and soft such that one can squeeze and bend the blade material by hand, somewhat analogous to a sponge. The blade may be soft enough to absorb at least a portion of the sound of a moving fluid and/or limit the reflection thereof, similar to radar absorbent material. Each blade may have a layered surface and/or a surface pattern that generates beneficial micro-turbulence. Also, each blade may have avian characteristics, including a feathered surface, serrated trailing edge and a comb-like surface on the leading edge. The number, size, depth, width, shape and configuration of the avian characteristics may be selected based on the desired performance of the blade.

For example, turbulence may be one of the most important phenomena that influence the performance of a blade. Blade behavior is a reaction to turbulence that controls the forces on the blade. Turbulence affects the speed of a blade and its ability to extract power from moving air or fluid. The surface pattern and/or avian characteristics of the blade may be selected to control turbulence for reduced drag and noise.

Each rotor blade set may incorporate a top or a bottom hub, or both, with each hub being affixed to a part of a rotating generator and/or a rotating generator element or the hub may be used to drive a generator; for example, directly, or through a gear system, or by a belt system, or other systems to transfer energy to one or more generators. Interconnecting hubs with each rotor blade set form a single assembly may provide aerodynamic efficiencies, reduced stress, minimized fluctuations in rotational speed, and a smooth, almost frictionless rotation of the blades. Similarly, interconnecting a rotating generator element via a hub into each rotor blade set may further eliminate the use of mechanical fittings and enhance aerodynamic performance.

The hubs and/or blades of each rotor blade set may be manufactured as individual pieces and then assembled into a single rotor blade set assembly. Alternatively, the generator hubs and/or blades of each rotor blade set may be molded as a single piece during the manufacturing process, alleviating the need for subsequent assembly.

The hubs may be in the form of a container, disc, rim or other configuration, usually of circular shape, and may support or contain parts of a generator, or parts to drive a generator, for example, a drive belt.

The turbine may have a variable axis design that permits omni-directional energy harvesting. A fluid moving in any direction may cause the blades to rotate, and lead to energy production. Accordingly, the turbine design may be used in many applications. In addition to harvesting wind or water energy, the design may perform similarly wherever there is a moving fluid. The turbine may work in cooperation with vents, blowers, ventilation systems, central heating systems, water mixers, boat propellers, moving vehicles, and/or other machines.

In one aspect, two or more rotor blade sets may be provided. Each rotor blade set may be configured to rotate independently or separately of the other rotor blade sets, but along the same axis of rotation and in the same or opposite direction. Each interior rotor blade set may be configured such that the blades are sufficiently close to the blades of the larger, adjacent rotor blade set to aerodynamically benefit from the effects of the larger, adjacent rotor blade set. Each rotor blade set may be held in place longitudinally and axially by a central, non-rotating axle.

In another aspect, one or more dedicated generator hubs may be interconnected with and/or integrated with each rotor blade set. Each dedicated generator hub may operate a generator and/or one or more generator elements. The dedicated generator hubs may be located at the top and/or bottom of each rotor blade set. Each dedicated generator hub may enclose and be affixed to the housing of a rotating generator. Each hub and encased generator may be rotatable about, and supported by, the central, non-rotating axle. As each dedicated generator hub rotates with the corresponding rotor blade set, so may the rotating generator and/or associated rotating generator elements.

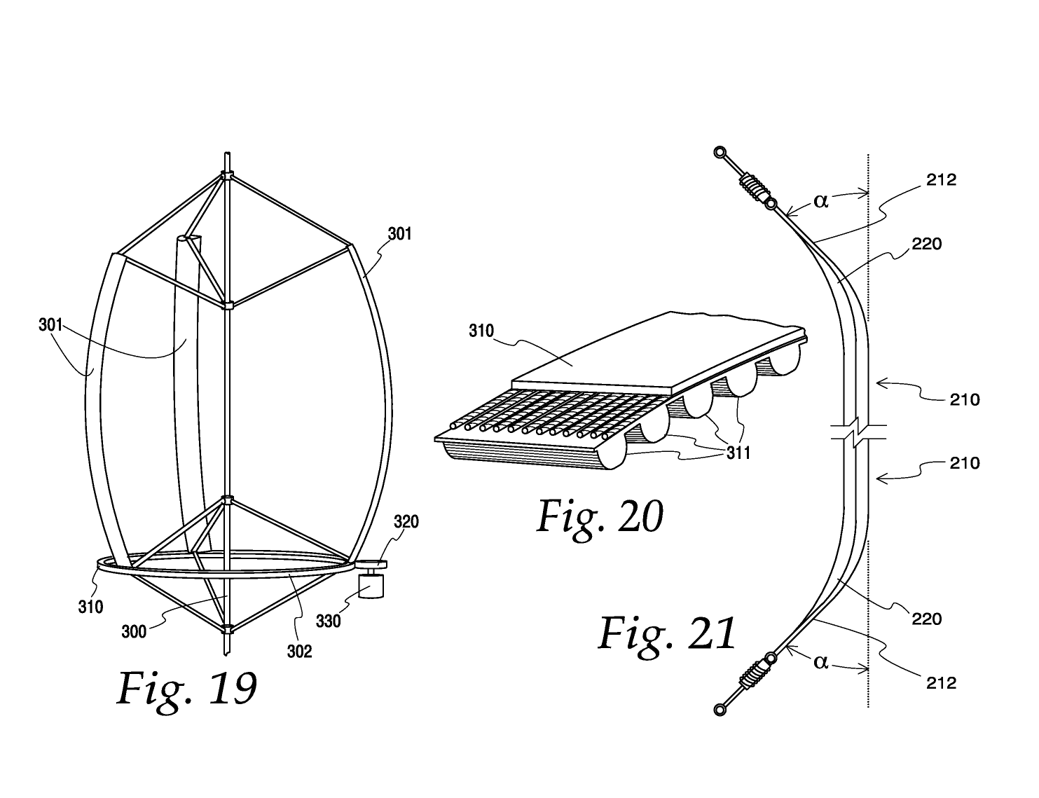

In still another aspect, the hub may drive one or more generators (See FIG. 19.)

### I. Enhanced Design

In general, the turbine may reduce vibration noise, alleviate run-away or break up in fast fluid conditions, and/or reduce excessive drag on the blades. Unlike typical designs, the turbine may provide efficient power production across the range of very low to very high fluid speed. In one embodiment, the turbine may begin operating in slow fluids moving at speeds less than about four miles per hour (mph) and continue to operate efficiently in fast fluids moving at speeds of, or even greater than, about sixty-eight mph.

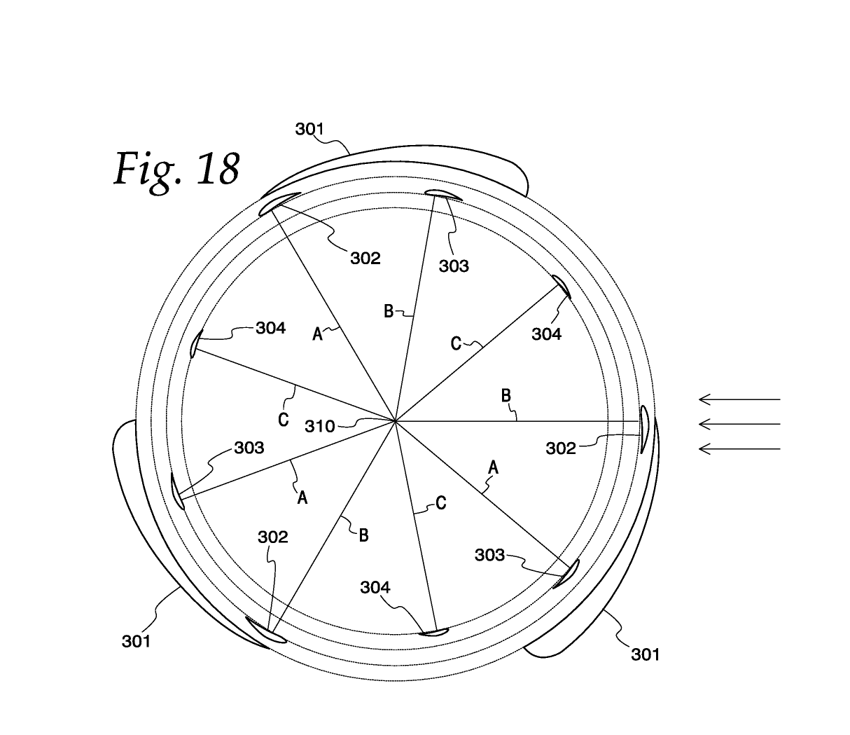

The turbine may include nested rotor blade sets shaped to change the direction of fluid flow. The kinetic energy of the moving fluid striking a blade of an outer rotor blade set may be converted into rotational energy of the blade. A lift effect may be created by an interior concave surface of the blade catching the moving fluid to rotate the blade. Simultaneously, it is believed that the exterior convex and/or interior concave blade surfaces may (1) accelerate the moving fluid, or a portion thereof, as the moving fluid traverses along each surface, and (2) then redirect the accelerated moving fluid toward the interior area of the turbine (See FIG. 18.)

For example, the curvature of the convex surface may be more pronounced than a slight curvature of the concave surface. The faster moving fluid may create an area of low pressure along the convex surface of the blade. With lower pressure on the exterior of the blade and higher pressure on the interior of the blade, the blade may be “sucked” in the direction of rotation.

In the nested blade arrangement, it has been found beneficial to maintain an approximately constant ratio of the chord length of the blades to their respective radii of rotation so as to obtain an approximately constant solidity for the different rotor blade sets.

The inner blades may benefit from the accelerated and redirected moving fluid and enjoy increased rotational speed as compared to the outer blades under the same flow condition. In one embodiment of nested rotors, an inner rotor blade set may rotate between approximately twenty (20%) and approximately thirty percent (30%) faster than an adjacent outer rotor blade set, or less, depending upon the load designed for the inner nested rotor. Additionally, during operation, the blade set of the inner rotor may automatically “find” an optimal speed of rotation that enhances energy extraction from the moving fluid flowing at a given speed. Changing the shape of the airfoil (or “fluid foil”) may alter the amount of moving fluid that is redirected, and the manner in which the flow of moving fluid is accelerated, onto the next nested rotor blade set.

The total system efficiency and output of the design of multiple rotor blade sets may be greater than the sum of individual rotor blade sets working spaced apart, or separately. Based on experiments, a single rotor blade set may extract about 25% of the energy of a moving fluid. Adding a second rotor blade set (to make a dual nested rotor blade set configuration) may result in the extraction of about 65% of the energy of the moving fluid. Adding yet another rotor blade set (to make a triple nested rotor blade set configuration) may result in the extraction of about 85% of the energy of the moving fluid. Thus, a dual or triple nested rotor blade set design may generate more than the energy of the rotor blade sets operating individually spaced in an un-nested manner. In other words, the same number of rotor blade sets may produce more energy in a nested arrangement, i.e., operating as a team—as compared to operating individually—may have synergistic results.

Conventional turbines may be prone to self-destruct if the wind reaches high speeds. To prevent “runaway” turbines, brakes must be installed. On the other hand, the present turbine may utilize blade twist to enable operation without the need of a conventional braking system. In addition, the generator may control speed of the rotor and blades, so as to achieve optimum performance. The specific twist of the blade may prevent the turbine from reaching excessive rotational speed. The force from the moving fluid pushing on the interior concave surfaces of the blades in the direction of the flow may be countered by the resistance of exterior convex surfaces of the same blades traveling against the flow. In fast fluid conditions, a maximum steady state speed of the blades may be reached, allowing the turbine to continue operating and alleviating the need to suspend energy production.

Further, the present embodiments may nearly eliminate stall when rotating as each blade in a rotor may rapidly convert turbulent moving fluid into blade rotation. The blade design may alleviate violent vibrations, which may cause premature blade failure, high noise level, and poor efficiency.

### II. Exemplary Turbine

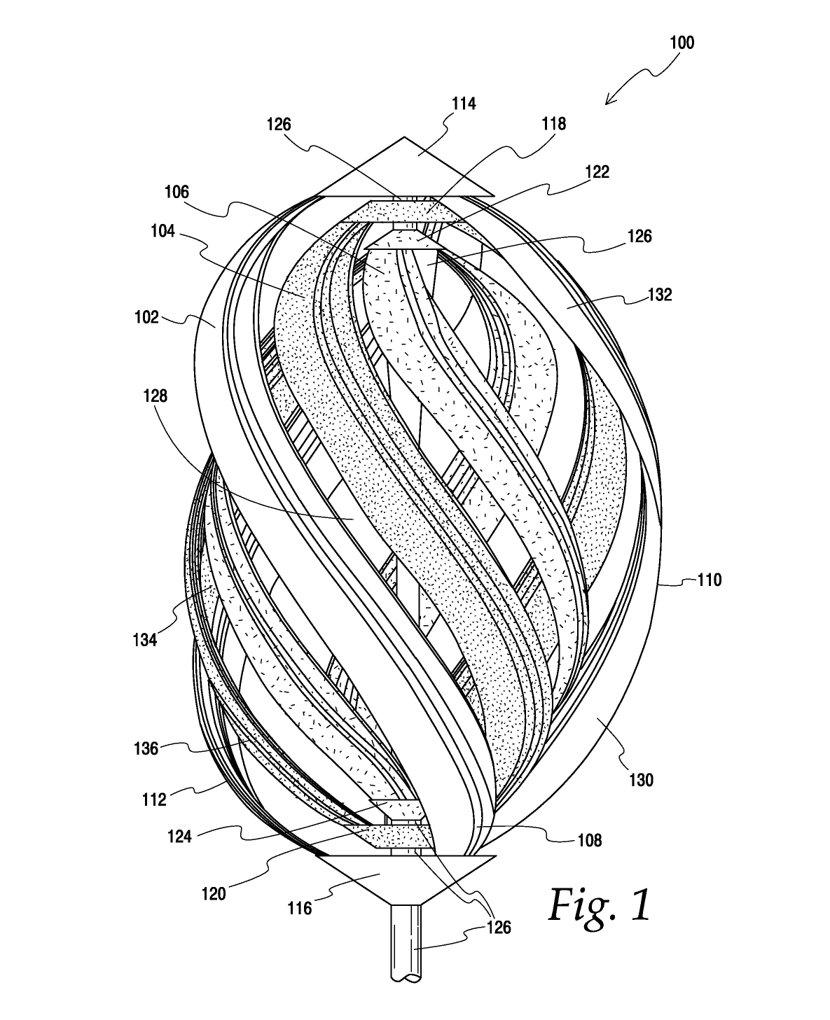

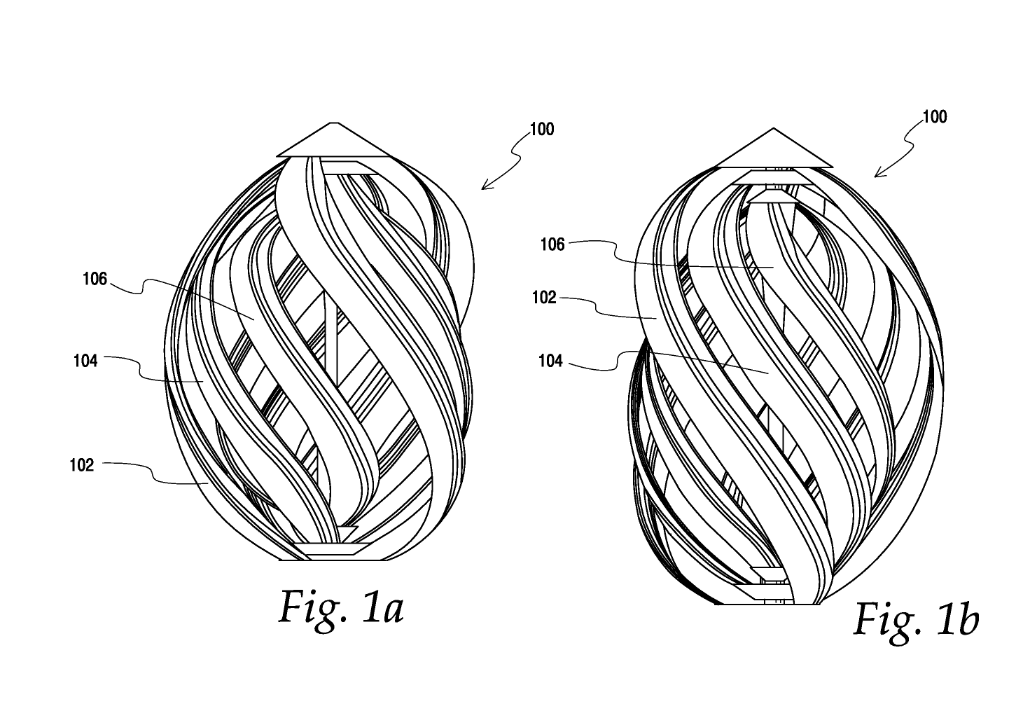

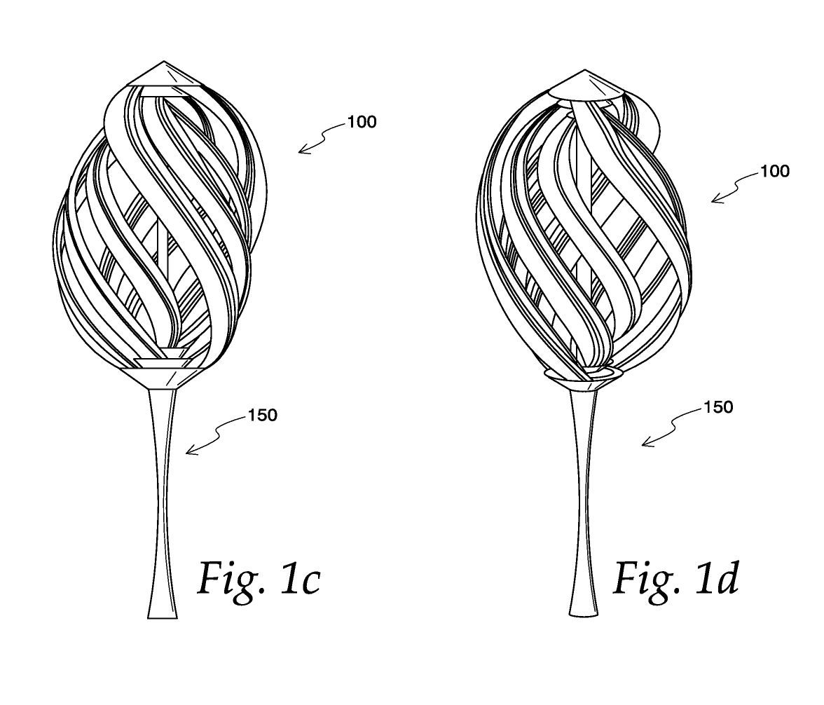

FIG. 1 illustrates an exemplary variable axis turbine 100 with three nested rotor blade sets 102, 104, 106. Each rotor blade set 102, 104, 106 may have three blades and may be interconnected with a top and a bottom dedicated generator hub. The hubs rotate about a center axis. The blades extend generally parallel to the center axis between the top and bottom hubs. As shown, the turbine 100 may have a first rotor blade set 102, a second rotor blade set 104, and a third rotor blade set 106. The first rotor blade set 102 may have a first blade 108, a second blade 110, and a third blade 112. The second rotor blade set 104 and third rotor blade set 106 may also have one or more blades.

The first rotor blade set 102 may have a dedicated top generator hub 114 and/or a dedicated bottom generator hub 116. The second rotor blade set 104 may have a dedicated top generator hub 118 and/or a dedicated bottom generator hub 120. The third rotor blade set 106 may have a dedicated top generator hub 122 and/or a dedicated bottom generator hub 124. The rotor blade sets 102, 104, 106 may be held in place axially by and rotate around a central, non-rotating axle 126. The turbine 100 may include additional, fewer, or alternate rotor blade sets, blades, generator hubs, and/or other components. The hubs may be of any diameter to allow best extraction of energy as well provide role as diffuser.

As depicted in FIG. 1, in one embodiment, the turbine 100 may include three nested rotor blade sets 102, 104, 106 each having three blades, for a total of nine blades. The turbine 100 may include a first set of blades 102 spaced from and arranged about an interior or central portion 128 of the turbine 100 for rotation together around the central portion 128 in a first rotational path and a second set of blades 104 constructed and arranged for rotation together around the central portion 128 in a second rotational path located inside of the first rotational path of the first set of blades 102. The second set of blades 104 may be positioned sufficiently close to the first rotational path of the first set of blades 102 so that by action of the fluid on the second set of blades 104, the second set of blades 104 will rotate in the same direction as the first set of blades 102 during the rotation of the first set of blades 102, and at faster or slower speeds depending on the design.

The turbine 100 may include a third set of blades 106 constructed and arranged for rotation together around the central portion 128 in a third rotational path located inside of the second rotational path of the second set of blades 104. The third set of blades 106 may be positioned sufficiently close to the second rotational path of the second set of blades 104 so that by action of the fluid on the third set of blades 106, the third set of blades 106 will rotate in the same direction as the second set of blades 104 during the rotation of the second set of blades 104, and at faster or slower speeds than the second set of blades depending on the design.

In one embodiment, the nested rotor blade sets 102, 104, 106 of turbine 100 may have the following dimensions (in meters):

| | | | | | | | | reynolds |
|---|---|---|---|---|---|---|---|---|
| | blade | chord | | swept | | radius/ | circumference/ | number at |
| | length | length | radius | area | solidity | chord | chord | 3 m/s |
| blades | 3.60 | 0.200 | 1.250 | 9 | 0.4800 | 6.25 | 39.250 | 214961.3 |
| 102 | | | | | | | | |
| blades | 3.50 | 0.185 | 1.150 | 8.05 | 0.4826 | 6.22 | 39.038 | 320131.1 |
| 104 | | | | | | | | |
| blades | 3.40 | 0.170 | 1.050 | 7.14 | 0.4857 | 6.18 | 38.788 | 332545.1 |
| 106 | | | | | | | | |

The first set of blades 102 may be mechanically interconnected or integrated with at least one or more generator hubs 114, 116. Each generator hub 114, 116 may operate a rotating generator, one or more rotating generator elements, and/or one or more non-rotating generator elements. The second set of blades 104 may be mechanically interconnected or integrated with at least one or more generator hubs 118, 120. Each generator hub 118, 120 may operate a rotating generator, one or more rotating generator elements, and/or one or more non-rotating generator elements. The third set of blades 106 may be mechanically interconnected or integrated with at least one or more generator hubs 122, 124. Each generator hub 122, 124 may operate a rotating generator, one or more rotating generator elements, and/or one or more non-rotating generator elements.

The central, non-rotating axle 126 may have a diameter of about one or several inches. Preferably, the axle 126 may have a diameter of approximately one inch. The axle 126 may be manufactured of steel or other material of sufficient strength to support the rotor blade sets longitudinally and axially. The interior of the axle 126 may be hollow to accommodate the running of electrical leads for the transfer of power generated. The electrical leads and other wiring may run from the rotating and/or non-rotating generator elements or plurality of elements through the internal portion of the axle 126 and ultimately to an electric grid. The central axle may be centrally located without obstruction of air patterns inside wind turbine. For example, the center axle may be supported by external structures such that the axle does not extend through the interior of the turbine.

As noted above, to take advantage of the aerodynamic effects of an adjacent rotor blade set, the rotor blade sets 102, 104, 106 may be positioned sufficiently close to one another such that there is co-action and/or synergistic result from the fluid action between each adjacent rotor blade set. The rotor blade sets 102, 104, 106 may be positioned sufficiently close to one another to increase the speed of an inner rotor blade set 104 as compared to the speed of the outer rotor blade set 102, which is a measurable and provable effect using various sensors, as shown in FIG. 14.

Without being bound by the following theory, and to help understand this effect, one may view the turbine design as allowing the inner rotor blades to “draft” or rotate at higher speeds due to one or more physical effects created by the outer rotor blades. As outer rotor blades rotate, each outer rotor blade may leave behind a wake or area of lower fluid pressure that may create aerodynamic efficiencies for the inner rotor blades. Alternatively or additionally, the inner rotor blades may benefit from the outer rotor blades accelerating and then redirecting at least a portion of the moving fluid into the rotational path of the inner rotor blades. Other theories may be envisioned. Whatever theory is correct does not matter; the synergistic result has been established experimentally.

Pictorially, as shown in FIG. 1, the outer rotor blades 102 may include blades having a cross-sectional area with a concavo-convex shape. A concave interior surface 130 and/or convex exterior surface 132 of the outer rotor blades 102 may be shaped to funnel the moving fluid onto the middle rotor blades 104. The moving fluid may be accelerated a first time as it traverses along the concave interior surface 130 and/or the convex exterior surface 132 before the accelerated moving fluid acts on the middle rotor blades 104.

Likewise, the middle rotor blades 104 may include blades having a cross-sectional area with a concavo-convex shape. A concave interior surface 134 and/or convex exterior surface 136 of the middle rotor blades 104 may be shaped to funnel the moving fluid onto the inner rotor blades 106. The moving fluid may be accelerated a second time as it traverses along the concave interior surface 134 and/or convex exterior surface 136 before the twice accelerated moving fluid acts on the inner rotor blades 106.

FIGS. 1a and 1b show the turbine 100 with an outer rotor blade set 102, a middle rotor blade set 104, and an inner rotor blade set 106. Moving from FIG. 1a to FIG. 1b depicts that each of the rotor blade sets 102, 104, 106 may rotate about the central, non-rotating axle. During operation, each of the rotor blade sets may rotate independently and separately of the remaining rotor blade sets. The middle rotor blade set 104 may rotate faster than the outer rotor blade set 102, and the inner rotor blade set 106 may rotate faster than the middle rotor blade set 104.

The nested blade sets enhance the ability of the turbine to extract energy from the wind as evident by the increased pressure drop in the wind pressure across multiple nested blade sets compared to a solo blade set. Referring to FIG. 18, there is illustrated diagrammatically another embodiment of the invention showing in cross-section four blade sets 301, 302, 303, 304, each of which in cross-section has its own circular rotational path indicated by the dotted lines. Each blade set contains three blades. Each blade set rotates in a circular path in the cross-section view having a different radius than the radius of the other blade sets. Thus, viewing the embodiment of FIG. 18 in cross-section, the outer blade set 301 rotates in a circular path defined by a larger radius than the second and next inward blade set 302. The radius of the circular path second blade set is indicated by solid lines A. The third blade set 303 rotates in circular path having a smaller radius than does the second blade set 302. The radius of the circular path of the third blade set 303 is indicated by the solid lines B. The fourth blade set 304 rotates in a circular path having a radius defined by the solid lines C. While the diagrammatic view of FIG. 18 shows circular paths, it should be understood that the blade sets may have blades with the curved configuration as the blade sets of FIG. 1 in which the blades are curved length-wise.

The blades 301 in the outer blade set are positioned equidistant apart. The blades of the inner blade sets 302, 303, and 304 are positions equidistant apart around the center axis 310 of the turbine. The blades in each blade set are equidistant apart, and balance of the turbine is achieved.

The multiple rotational blade sets 301, 302, 303, and 304 increase the drop in pressure of the fluid, such as wind, as it passes through the turbine, thereby increasing the efficiency of the extraction of energy.

In the FIG. 18 embodiment, an outer blade set 301 may employ large wind deflectors that may function as wind diffusers, thereby reducing the wind pressure, and providing an increased pressure drop, and increasing air flow to the inner sets of blades 302, 303, and 304. Each inner set of blades may rotate faster than the next outer set of blades, for example, blade set 304 may rotate faster than blade set 303, blade set 303 may rotate faster than blade set 302, and blade set 302 may rotate faster than the outer large blades 301, so that the multiple blade sets work together to provide increased torque and power from the wind, compared to a solo blade set.

The inner blade sets 302, 303, 304 may have the specific airfoil design shown in FIG. 17, but with each blade set of a different chord length as measured from the leading edge to the trailing edge of the blade. For example, the airfoil of the blades in blade set 302 may have a chord length of 0.25 meter, the airfoil of the blades of blade set 303 may have a chord length of 0.23 meter, and the airfoil of the blades of blade set 304 may have a chord length of 0.21 meter. In summary, the airfoil of the inner blade sets may have progressively smaller chord lengths in their airfoils from the outer to the innermost blade set.

The blades in the outer blade set 301 may have a special airfoil configuration designed to function as a diffuser. As illustrated in FIG. 18, the airfoil of the large blades 301 having the leading edge directed clockwise while the airfoil of the inner blades are directed counter clockwise.

The turbine blades may have the specific airfoil design shown in FIG. 17. The airfoil design 305 that may be used, for example, in blades 302, 202, and 304 shown in FIG. 18 embodiment. The airfoil 305 has a leading edge 306, a trailing edge 307, and outer camber 308, and an inner camber 309. The outer camber 308 is longer than the inner camber 309 in order to provide lift to the blade. The chord of the airfoil is the distance between the leading edge 306 and trailing edge 307, depicted by the line in FIG. 17.

Other embodiments may be used. For example, a shield may be added that may redirect entering fluid flow onto the blades and/or shield the blades on the return side from oncoming fluid.

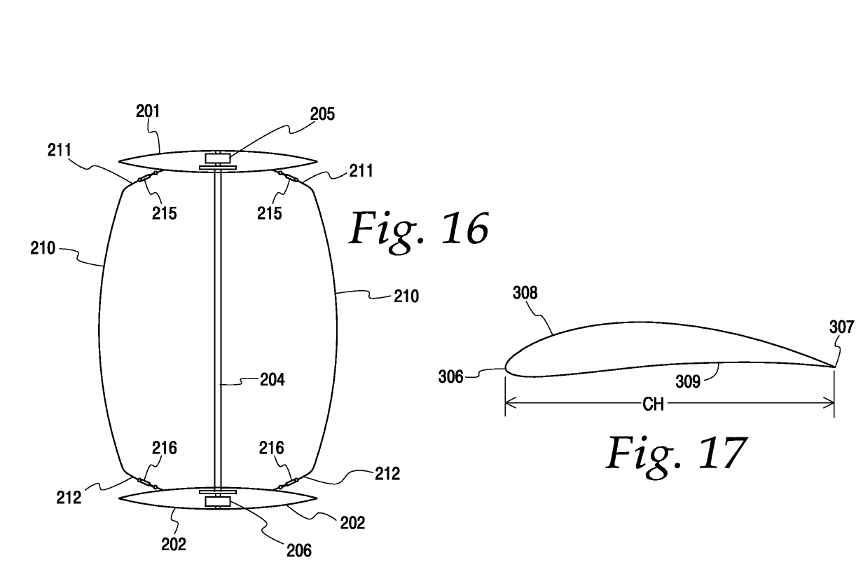

Also, by way of example, flow concentration devices may be employed to concentrate the flow of the fluid. Referring to FIG. 16, there is shown a rotor 200 for a wind turbine. The rotor is provided with an upper disc 201 and a lower disc 202 that are rotatably mounted on non-rotatable shaft 204 with bearings 205 and 206. Blades 210 are attached to the discs 201 and 202 through top distal sections 211 and bottom distal sections 212 at the upper and lower sections of the blades for rotation on bearings 205, 206. Shock absorbers 215, 216, such as used in motorcycles and cars, may be located between the top and bottom distal sections and the discs.

The discs 201, 202 also may serve as a free wheel, or gyroscope, and reduce balance and suspension problems of the rotor and wind turbine. For the purpose of balance, the discs may be provided with weights, or an outer rim. For example, the discs may include one or more compartments at least partially filled with liquid and in fluid communication with each other so as to increase the gyroscopic effect.

By using the one or more of the above-described disc devices and techniques, there is provided fluid flow boundaries different from what has been accomplished heretofore in wind turbines. By employing the techniques of air boundaries, extraction of energy from the moving fluid may be more efficient. Thereby, the power output of a wind turbine may be increased without increasing the size of the wind turbine. Testing indicates that multiple sets of nested blades mounted to operated independently but as one system can effectively work together to harvest more power than a single set of blades of the same diameter.

In the multiple nested blades as disclosed herein, the cross-sectional configurations of each set of blades may have its own unique specifications. For example, the outer blades may have a longer span and larger chord than the inner blades. Referring to FIGS. 17 and 18, the outer set of blades 301 may have a relatively large chord, whereas the first set of inner blades 302 may have a chord of 0.25 meters, the next set of inner blades 303 may have a chord of 0.23 meters, and the most inner set of blades 304 may have a chord of 0.21 meters. Preferably the ratio of the chord length to the radius of rotation is approximately the same for all the inner blades 302, 303, and 304 so as to provide optimum performance.

The outer set of large blades 301 may serve as a diffuser, providing a pressure drop as the wind traverses the large blades, thereby increasing the efficiency of fluid flow on the next sets of blades 302, 303 and 304. The result may improve the rotational speed of the next set of blades.

By using the one or more of the above-described devices and techniques, there is provided fluid flow boundaries different from what has been accomplished heretofore in wind turbines. By employing the techniques of air boundaries, and pressure drop, extraction of energy form the moving fluid is more efficient. Thereby, the power output of a wind turbine may be more efficient without increasing the diameter of the wind turbine. Testing indicates that multiple sets of nested blades mounted to operate independently but as one system can effectively work together to generate more power than a single set of blades of the same diameter.

### A. Wind Tunnel Testing

Wind tunnel testing revealed some unexpected results and a synergistic relationship between the nested rotor blade sets. The following phenomena were revealed: (1) an inner rotor blade set may rotate faster than an outer rotor blade set; (2) nested rotor blade sets may enhance energy extraction; and (3) the blade design itself may regulate the maximum speed of blade rotation.

During testing, the blades accelerated to a point of equilibrium, and once a steady state rotational speed was reached, the rotational speed of the blades did not increase further as entering wind speed continued to increase. Additionally, by mixing smoke with the air entering the wind tunnel, one could observe air being redirected and projected in multiple directions. The action observed indicates a near complete extraction of energy from the entering moving fluid, leaving it to “puddle or pool” behind the turbine blades. Similar results may be observed from the flow of water after it passes through a highly efficient water mill. The water may almost come to a standstill below the outlet of the waterwheel due to most of the energy being transferred, leaving the water with little energy or momentum to continue flowing forward. With the present embodiments, moving fluid may be redirected multiple times, i.e., by each rotor blade set.

Testing further revealed that higher than expected efficiencies may be achieved due to the synergistic positioning of the rotor blade sets. Although difficult to fully explain even in hindsight, the beneficial results of a nested rotor blade set configuration may be experimentally verifiable. Table I below shows exemplary experimental results of wind tunnel testing of a nested embodiment of the turbine shown in FIG. 1. It was proven that each inner rotor blade set may rotate faster than the adjacent, outer, and larger rotor blade set during operation.

The embodiment of the turbine of FIG. 1 used for testing as reported below in Table I had a height of about 92 centimeters, and the blades in the nested rotor assemblies of this turbine had the following dimensions:

| | Height (cm) | Chord (cm) | Radius (cm) | Length (cm) |
|---|---|---|---|---|
| Blades of | 88 | 11 | 24 | 118 |
| Rotor 102 | | | | |
| Blades of | 80 | 9 | 18 | 86 |
| Rotor 104 | | | | |
| Blades of | 72 | 7 | 12 | 57 |
| Rotor 106 | | | | |

The radius for each blade was measured along its largest dimension perpendicular to the center axis of the turbine. The blades each had a convex (bow) curve relative to the center axis and 120° helical twist, as illustrated in FIG. 1. The ratio of the radius to the chord length was approximately two (2) for each blade set.

Table I shows moving fluid speed in meters per second (m/s). The fluid speed was generated by a fan blowing air at various revolutions per minute (rpm). Blade rotation is also shown in rpm. Rotor assembly no. 1 is the largest and outer rotor assembly. Rotor assembly no. 2 is the middle rotor assembly. Rotor assembly no. 3 is the smallest and inner rotor assembly. The torque generated on rotor assembly no. 1 by the moving fluid at 1700 and 1800 fan rpm was measured and is shown in units of Newton centimeters (N-cm).

TABLE I
EXPERIMENTAL RESULTS

| | | Rotor | Rotor | | |
|---|---|---|---|---|---|
| WIND | | Assembly | Assembly | Rotor Assembly | |
| SPEED | FAN RPM | No. 1 | No. 2 | No. 3 | Torque |
| 1.59 | 900 | 42.53 | 67.93 | 77.33 | |
| 1.99 | 1000 | 36.33 | 70.33 | 89.87 | |
| 2.31 | 1100 | 43.33 | 83.20 | 110.93 | |
| 2.69 | 1200 | 51.80 | 94.20 | 119.60 | |
| 2.97 | 1300 | 60.40 | 105.27 | 130.93 | |
| 3.24 | 1400 | 66.27 | 113.73 | 142.53 | |
| 3.44 | 1500 | 69.60 | 120.13 | 159.20 | |
| 3.72 | 1600 | 76.73 | 130.20 | 179.20 | |
| 3.88 | 1700 | 90.71 | 144.36 | 187.43 | 134.14 |
| 3.97 | 1800 | 109.67 | 151.47 | 201.60 | 162.47 |

Wind tunnel testing also confirmed that the rotatable rotor assemblies may start to rotate at very low moving fluid speed. FIG. 14 graphically depicts exemplary wind tunnel testing results 1400. As shown in FIG. 14, the middle rotor assembly may rotate faster than the outer rotor assembly, and the inner rotor assembly may rotate faster than the middle rotor assembly. FIG. 14 also illustrates that all of the rotor assemblies may start to rotate in fluids moving very slowly. In one embodiment, the turbine may be self-starting in fluids moving as slow as about 1.59 m/s or approximately 3.6 mph.

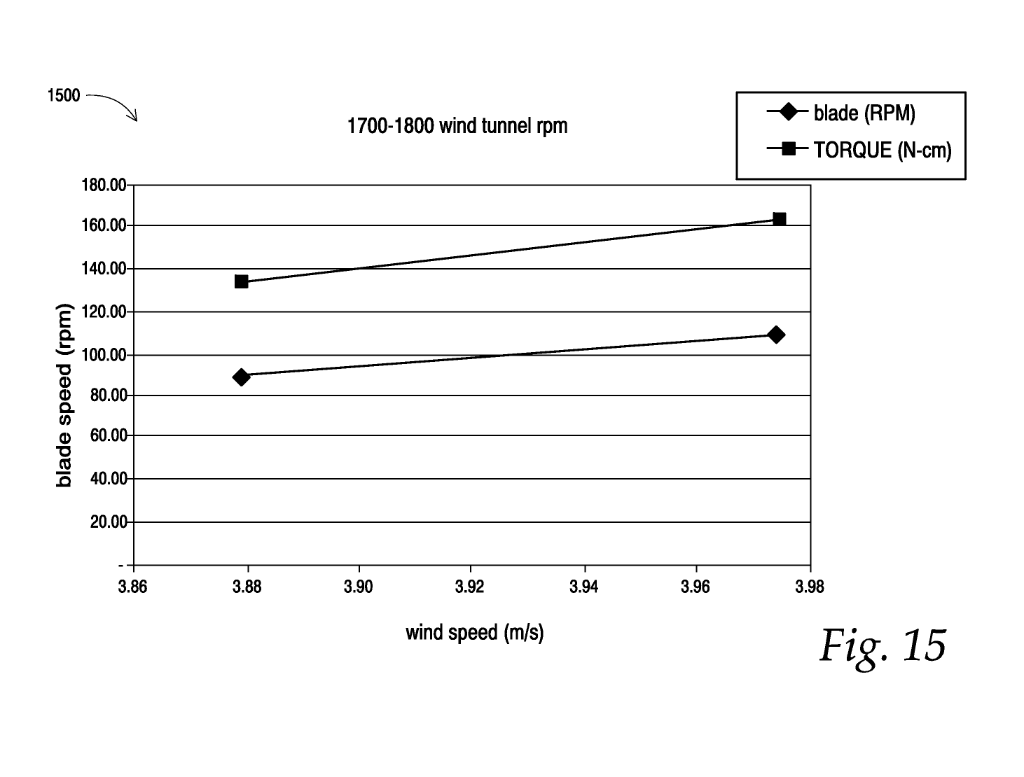

FIG. 15 illustrates an exemplary relationship between the speed of an outermost rotor assembly and the torque generated by the outermost rotor assembly. The torque generated by the outermost rotor assembly shown is due to the force of a moving fluid traveling at 3.88 m/s to 3.97 m/s acting on the blades of the outermost rotor assembly.

### B. Variable Axis Turbine

The turbine may have a “variable axis” design. The variable axis turbine may permit omni-directional energy recovery from a moving fluid traveling in any direction. The turbine may be mounted vertically, horizontally, or at any angle in between and may still generate power from a moving fluid flowing in a variable direction. Even a fluid flowing along or at a slight angle to the longitudinal axis of blade rotation may rotate the blades as would preferably a fluid flowing perpendicular to the longitudinal axis of blade rotation. As a result, the turbine may have a multi-angle mounting capability, and may be mounted on a variable axis post, axle, or other base inclined at any angle.

The variable axis design may facilitate (1) symmetry around the vertical axis and allow operation with all moving fluid directions, eliminating the need for a mechanism for directing the moving fluid; (2) placing heavy generator elements at locations that may enhance control and distribution of the associated weight; (3) reducing high stress and fatigue from gravitational forces acting on the blades when rotating; and (4) easier installation. The flexible mounting design may be particularly beneficial when considering various energy recovery models such as capturing the energy from exhaust vents, building HVAC systems, wind generated by frequently passing cars on a highway, trains, or subway cars, and/or other applications.

### C. Self-Balancing

The turbine may provide a self-balancing or “carpeting” effect. As seen in nature, once the wind strength reaches a specific point, trees and grass bend to reduce exposure to the wind. With the present embodiments, the turbine may not require a moving shaft, but rather each set of blades and hubs may rotate separately, and generators may be interconnected with the rotor blade sets via the hubs. This type of configuration may allow the turbine design to include a flexible base that may bend and reduce moving fluid exposure to the turbine in extreme fluid conditions.

The rotatable rotor assemblies may be mounted on or interconnected with the flexible base. The flexible base may be manufactured from a springy or other material. The turbine may include other self-balancing features, such as (1) single, double, or multiple flexible bases; (2) a single, convex flexible base; or (3) multiple flexible bases, such as a dedicated flexible base for each rotor assembly and/or in which each flexible base is nested within an adjacent flexible base.

Other self-balancing devices may be employed such as providing the rotor one or more discs or rims, or other circular member, acting as a gyroscope, illustrated by disc 202 in FIG. 16.

FIGS. 1c and 1d illustrate an exemplary self-balancing turbine 100. The turbine 100 may be mounted on top of a flexible base 150 manufactured from flexible material. The flexible base 150 may be manufactured from fiberglass, rubber, plastic, polymers, and/or other flexible material. During fast fluid conditions, the flexible base 150 may bend and alter the orientation of the turbine 100 away from the direction of the oncoming moving fluid. As a result, the stresses experienced by the turbine 100 due to the force of the moving fluid may be reduced. The flexible base, or support, may be designed to permit the turbine to incline from vertical under predetermined wind forces, or speeds, for example, to bend under at least a strong breeze or higher.

FIG. 2 illustrates an exemplary self-balancing rotor blade set 200 with an alternate exemplary flexible base 212. The rotor blade set 200 may include three blades 202, 204, 206 interconnected by a top and/or bottom generator hub 208, 210. As shown, the bottom generator hub 210 may be mounted on top of a spring 212 or a spring-like structure. Alternate flexible bases may be used.

### III. Other Exemplary Turbines

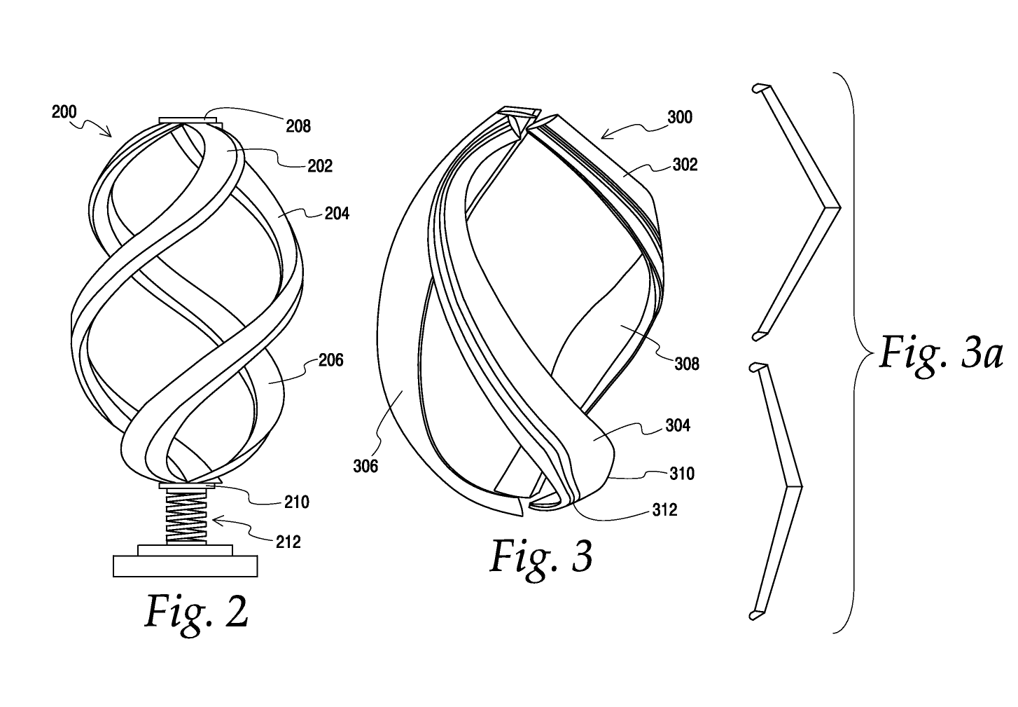

FIG. 3 illustrates another exemplary blade design 300. FIG. 3 shows blades 302, 304, 306 with a different and more pronounced curvilinear arc and twist. The blades 302, 304, 306 may have a concave-like interior surface 308 that faces the interior of the turbine. The concave-like interior surface 308 may be smooth and shaped similarly to that of the concave side of a sail catching the wind.

The blades 302, 304, 306 may have a convex-like exterior surface 310 that faces outward from the interior of the turbine. The convex-like exterior surface 310 may be shaped similarly to that of the convex side of a sail catching the wind. The convex-like exterior surface 310 may be smooth, but preferably may have a surface morphology that generates beneficial micro-turbulences. For instance, FIG. 3 depicts that the exterior blade surface may be layered 312. The layered surface 312 may include one or more overlapping or other layers, and the edges of the layers may generate turbulence during operation.

Other blade designs, in addition to the designs of FIGS. 1, 2, and 3, may be used. For instance, at least a portion of the blades may include other geometric-type surfaces. For example, the blades may include oval, square, rectangular, circular, straight, diamond, curved, and/or other geometric-shaped surface portions.

Further, other blade shapes or configurations in addition to the helical shape of FIGS. 1, 2 and 3 may be used. For example, the blades may have a swept wing shape, as shown in FIG. 3a.

FIG. 4 illustrates an exemplary set of blades 402, 404, 406 of different longitudinal length and width such that the rotor blade sets may physically fit inside of one another. The rotor blade sets may be configured such that adjacent rotor blade sets are between approximately one to approximately six inches apart when stationary. Preferably, the blades will be positioned such that the adjacent rotor blade sets are approximately four inches apart.

In one embodiment, the outer rotor blade set 402 may have a longitudinal length A of approximately ninety-six (96) inches, the middle rotor blade set 404 may have a longitudinal length B of approximately eighty-eight (88) inches, and the inner rotor blade set 406 may have a longitudinal length C of approximately eighty (80) inches.

Each rotor blade set may have a maximum blade rotational path at the mid-height of the blades. The outer rotor blade set 402 may have blades with a maximum blade rotational path having a diameter D of approximately seventy-eight (78) inches, the middle rotor blade set 404 may have blades with a maximum blade rotation path having a diameter E of approximately sixty-six (66) inches, preferably approximately 66.01 inches. The inner rotor blade set 406 may have blades with a maximum blade rotational path having a diameter F of approximately fifty-eight (58) inches, preferably approximately fifty-eight and 0.01 (58.01) inches.

Referring back to FIG. 1, each rotor blade set 102, 104, 106 may have a minimum blade rotational path at the top and/or bottom of the blades, such as where the top and/or bottom ends of the blades are interconnected with a hub 116, 120, 124. The outer rotor blade set 102 may have a minimum blade rotational path of between approximately twenty-four and approximately twenty-six (26) inches. The middle rotor blade set 104 may have a minimum blade rotational path of between approximately seventeen (17) and approximately eighteen (18) inches. The inner rotor blade set 106 may have a minimum blade rotational path of between approximately ten (10) and approximately eleven (11) inches.

The blades of the outer rotor blade set 102 may have top and/or bottom ends. At approximately six (6) inches from a top and/or bottom end, each outer blade may have a maximum cross-sectional length of approximately seven and a half (7½) inches and a maximum cross-sectional thickness of approximately 1.34 inches. The cross-sectional length and thickness of the outer blades may expand rapidly from the top and/or bottom ends to a top and/or bottom inner cross-sectional area, respectively. Each inner cross-sectional area may be approximately sixteen and a half (16½) inches from the top or bottom end of an outer blade. The top and/or bottom inner cross-sectional areas of an outer blade may have a maximum cross-sectional length of approximately eleven and a quarter (11¼) inches, and a maximum cross-sectional thickness of approximately two (2) inches.

From the top and/or bottom inner cross-sectional areas, the cross-sectional length and thickness of each outer blade may slowly further expand to a maximum at a mid-height point of the blades. At the mid-height point, the outer blades may have a largest maximum cross-sectional length of approximately fifteen (15) inches and a largest maximum cross-sectional thickness of approximately 2.65 inches.

The blades of the middle rotor blade set 104 may have top and bottom ends. At approximately six (6) inches from a top and/or bottom end, each middle blade may have a maximum cross-sectional length of approximately 6.90 inches and a maximum cross-sectional thickness of approximately 1.22 inches. The cross-sectional length and thickness of the middle blades may expand rapidly from the top and/or bottom ends to a top and/or bottom inner cross-sectional area, respectively. Each inner cross-sectional area may be approximately fifteen and a half inches (15½) from the top or bottom end of a middle blade. At the inner cross-sectional area, the middle blades may have a maximum cross-sectional length of approximately 10.35 inches and a maximum cross-sectional thickness of approximately two (2) inches.

From the top and/or bottom inner cross-sectional areas, the cross-sectional length and thickness of each middle blade may slowly further expand to a maximum at a mid-height point of the blades. At the mid-height point, the middle blades may have a largest maximum cross-sectional length of approximately 13.8 inches and a largest maximum cross-sectional thickness of approximately 2.44 inches.

The blades of the inner rotor blade set 106 may have top and bottom ends. At approximately six (6) inches from a top and/or bottom end, each inner blade may have a maximum cross-sectional length of approximately 6.35 inches and a maximum cross-sectional thickness of approximately 1.12 inches. The cross-sectional length and thickness of the inner blades may expand rapidly from the top and/or bottom ends to a top and/or bottom inner cross-sectional area, respectively. Each inner cross-sectional area may be approximately fourteen and a half (14½) inches from the top or bottom end of an inner blade. The top and/or bottom inner cross-sectional areas of the inner blades may have a maximum cross-sectional length of approximately 9.52 inches and a maximum cross-sectional thickness of approximately two (2) inches.

From the top and/or bottom inner cross-sectional areas, the cross-sectional length and thickness of each inner blade may slowly further expand to a maximum at a mid-height point of the blades. At the mid-height point, the inner blades may have a largest maximum cross-sectional length of approximately 12.7 inches and a largest maximum cross-sectional thickness of approximately 2.24 inches.

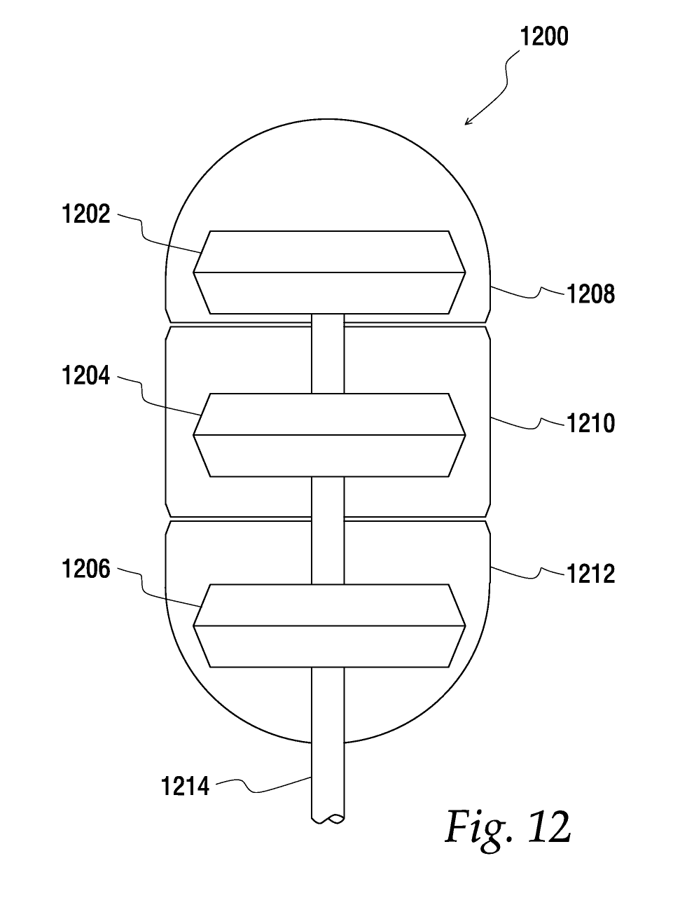

The turbine 100 may include three bottom hubs 116, 120, 124. Each bottom hub may be arranged one on top of the next, with a small gap of preferably between approximately one (1) to approximately two (2) inches in between each hub. In one embodiment, the inner bottom hub 124 may have a bottom, horizontal surface cutting across the axle 126 that is approximately five (5) inches wide, the middle bottom hub 120 may have a bottom, horizontal surface that is approximately nine (9) inches wide, and the outer bottom hub 116 may have a bottom, horizontal surface that is approximately thirteen (13) inches wide (not shown in FIG. 1). Blades, rotor assemblies, and/or generator hubs having additional, fewer, and/or alternate dimensions may be used, including the exemplary hubs shown in FIG. 12.

### IV. Exemplary Blade Curvature

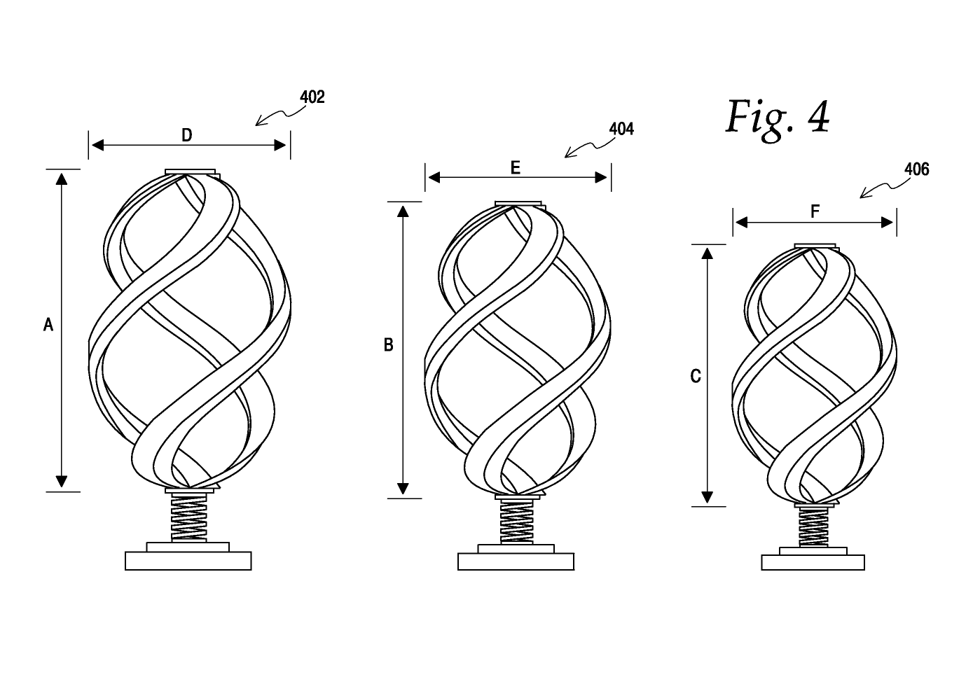

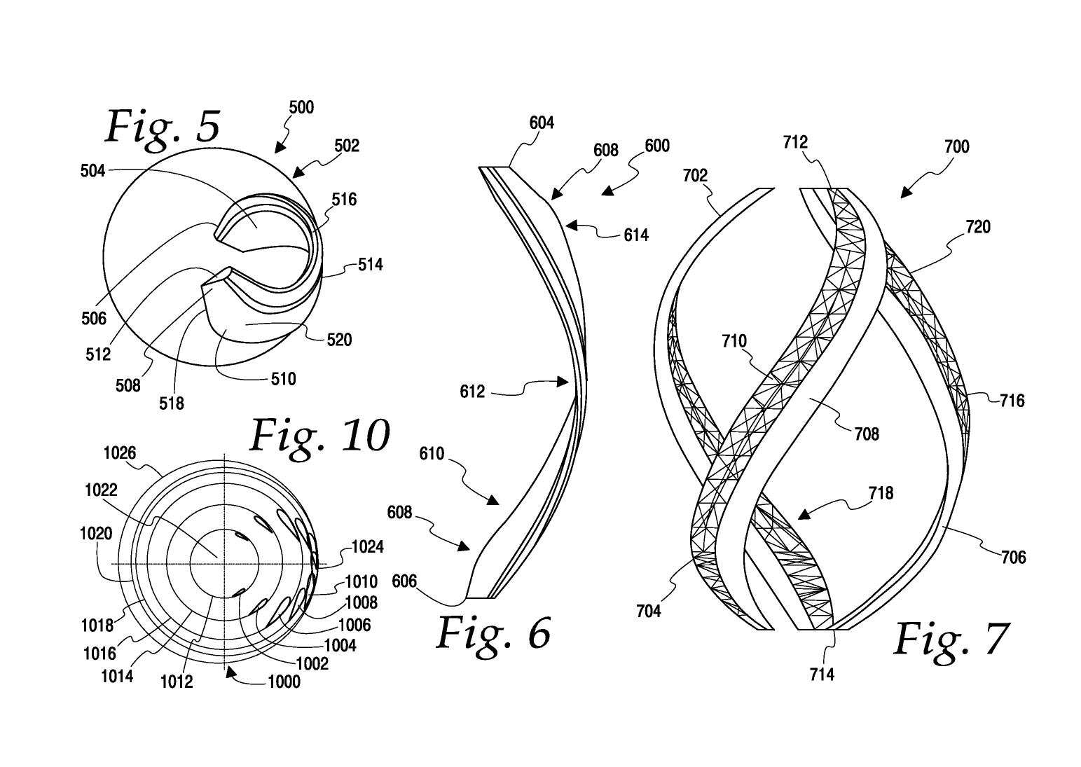

FIG. 5 illustrates an exemplary top plan view of a blade 500. As shown the blade 500 may be twisted in multiple directions. The blade 500 may have a longitudinal twist extending the length of the blade 500 and/or an axial twist running the width of the blade. The blade 500 may rotate longitudinally in a circular rotational path 502. The rotational path 502 shown may be the rotational path of a longitudinal mid-point 514 of the blade 500.

The blade 500 may have a rounded concave interior surface 504 that extends the length of the blade 500 from the bottom 506 of the blade 500 to the top 508. Both the bottom 506 and top 508 of the blade 500 may have an expanded flap-like area 510. The flap-like area 510 of the blade 500 may expand from, and have a larger surface area as compared to, the bottom 506 and top 508 ends of the blade 500.

As shown at the top 508 end of the blade 500, the cross-sectional shape 512 of the blade 500 may have an oval shaped leading edge 516 and a cone shaped trailing edge 518. The leading edge 516 may be layered. The cross-sectional area 512 may also include a concave interior surface 504 (facing the interior of the turbine) and a convex exterior surface 520 (facing the exterior of the turbine).

Due to the axial and longitudinal twist of the blade 500, as the blade 500 rotates, the blade 500 may reach a point where about twenty percent (20%) of the surface facing the direction of the moving fluid may be the convex exterior surface 520, while about eighty percent (80%) of the surface facing the direction of the moving fluid may be the concave interior surface 504. Unlike a Darrieus design in which the top and bottom of the blade attach to a rotating axle within the same vertical plane, with the present embodiments, the top 508 and bottom 506 of the blade 500 end up attached to rotor assemblies in different vertical planes or orientations due to the longitudinal twist. In other words, the twist is such that the top end of a blade is at a different location within the blade rotational path as compared with the bottom end of a blade, such as illustrated in FIG. 10.

The longitudinal twist may be stated as a mathematical function, such as 360 degrees of rotation about the central axle divided by the number of blades attached to a rotatable hub. For instance, if three blades are used, the twist may be preferably 120 degrees to facilitate appropriate blade spacing. If four blades were used, the twist may be preferably 90 degrees to facilitate appropriate blade spacing, and so on.

The cross-sectional shape 512 may extend the length of the blade, but having different dimensions. The cross-sectional area may be smallest at the bottom 506 and top 508 ends of the blade 500 and expand rapidly to the flap-like area 510. The cross-sectional area may then continue to expand from the flap-like area 510 to the longitudinal mid-point 514 of the blade 500. Each blade may have additional, fewer, or alternate surfaces, dimensions, and/or characteristics.

FIG. 6 illustrates an exemplary side view of a blade 600. As shown, both the bottom and top portions of the blade 600 may include a flap-like portion 608 that may provide an expansive cross-sectional area as compared to the bottom and top ends 604, 606. During use, each blade will rotate through the position shown in FIG. 6. If the moving fluid is flowing into FIG. 6, the longitudinal mid-point 612 of the blade 600 may have both an interior concave surface 610 and an exterior convex surface 614 that may twist or otherwise transition to be substantially parallel with the direction of the moving fluid with the blade 600 at the position shown in FIG. 6.

Also at the blade position shown in FIG. 6 and with the moving fluid flowing into FIG. 6, the bottom flap-like portion 608 may present a twisted concave interior surface 610 to the direction of oncoming moving fluid. The twisted concave interior surface 610 may catch the moving fluid, causing at least in part, the blade 600 to rotate. The twisted concave interior surface 610 may redirect the respective portion of the moving fluid traversing its surface toward inner blades. The exact manner of redirection may depend on the blade 600 shape, twist, surfaces, and/or other characteristics.

Also at the blade position shown in FIG. 6 and with the moving fluid flowing into FIG. 6, the top flap-like portion 608 may present a twisted convex exterior surface 614 to the direction of oncoming moving fluid. The twisted convex exterior surface 614 may be pushed by the moving fluid, which may contribute to the rotation of the blade 600. The twisted convex exterior surface 614 may redirect at least a respective portion of the moving fluid traversing its surface toward inner blades and/or create a wake effect. The exact manner in which the twisted convex exterior surface 614 redirects moving fluid may be determined by the blade 600 shape, twist, surfaces, and/or other characteristics.

The flexibility and/or density of each blade may vary longitudinally from mid-point to top and bottom, and/or axially from leading edge to trailing edge. FIG. 7 illustrates an exemplary rotor blade set 700 having a variable flexibility. The rotor blade set 700 may have a first blade 702, a second blade 704, and a third blade 706. Each blade may have a leading portion 708 and a trailing portion 710. The leading portion 708 may be manufactured to be more rigid (and/or more stiff) and less flexible as compared to the trailing portion 710, which may be manufactured to be relatively more flexible than the leading portion 708. In other words, blades 702, 704, 706 may have a variable stiffness moving along the width and/or height, such as increased axial and/or longitudinal stiffness on the leading edge and/or ends, respectively, and relatively lower axial and/or longitudinal stiffness on the trailing edge and/or mid-height point, respectively. The blades 702, 704, 706 may have different bending, elasticity, and durability characteristics moving along the width and/or height.

The width of each blade may be a minimum at a longitudinal top 712 and a longitudinal bottom 714 and a maximum at a longitudinal mid-point 716. The longitudinal mid-point 716 may be manufactured to have a different flexibility (stiffness) as compared to the longitudinal top 712 and bottom 714. For instance, the ends of the blades 702, 704, 706 may be more rigid or stiff for interconnection with the hubs.

FIG. 7 depicts that the blades 702, 704, 706 may be manufactured using a reinforcing material (for example glass, carbon, basalt, hemp, or flex) impregnation process. The reinforcing materials and resin composite may be position horizontally, vertically, diagonally, and/or along curved lines under precise computer control, as represented by lines 718, 720. The density of the resins and geometry of reinforcing materials may be varied, which may contribute to the manufacture of a variable flexibility or resiliency blade. Comparatively, the leading portion 708 may be manufactured to have more, or even substantially more, composite structures than the trailing portion 710 to provide a stronger leading portion 708 and a lighter trailing portion 710.

### V. Exemplary Blade Cross-Sectional Area

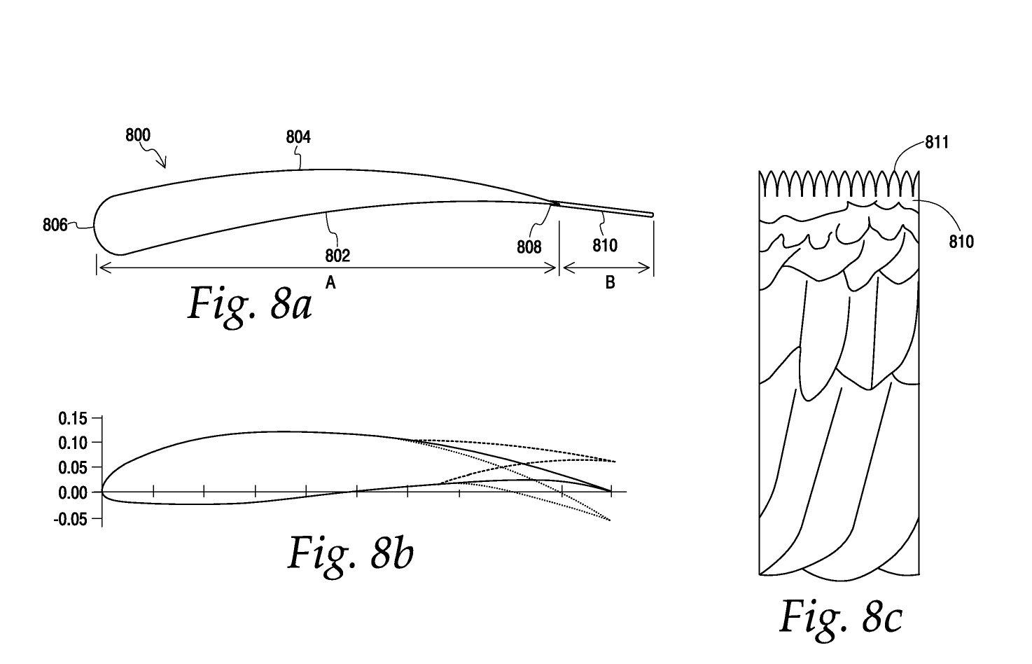

FIG. 8a illustrates one exemplary blade cross-sectional area 800. Each blade may have a cross-sectional area 800 with a tear drop, concavo-convex shape. The cross-sectional area 800 may include a concave surface 802, a convex surface 804, an oval leading edge 806, a pointed trailing edge 808, and a flexible flap 810. The cross-sectional area 800 may include additional, fewer, or alternate characteristics.

The concave surface 802 may face the interior of the turbine. The concave surface 802 may preferably be a smooth surface, but alternatively may be textured to create micro-turbulences. The concave surface 802 may accelerate at least a portion of a moving fluid and then redirect the accelerated moving fluid into an interior portion of the turbine. Alternatively, the surface facing the interior of the turbine may be relatively flat with respect to the surface facing the exterior of the turbine.

The convex surface 804 may face the exterior of the turbine. The convex surface 804 may be a smooth surface, but preferably is textured to create micro-turbulences. The convex surface 804 may accelerate at least a portion of a moving fluid and then redirect the accelerated moving fluid into an interior portion of the turbine.

The convex surface 804, in cooperation with the concave surface 802, may create a lift effect on the blade in the direction of rotor assembly rotation. As shown, the convex surface 804 may be longer than the concave surface 802 across the width of the blade. In one embodiment, the convex surface may be approximately ten (10%) to approximately thirty percent (30%) longer than the concave surface.

The leading edge 806 may be rounded and/or curved. Alternatively, the leading edge may have a pointed shape. Opposite to the leading edge 806, the blade may be cone and/or comet tail shaped 808. A flap 810 may be connected to the cone shaped area 808. In one embodiment, the cross-sectional area 800 of the blades may be shaped similarly to and operate analogously to the cross-sectional area described in Rekret Canadian Patent Application No. 2,628,855, entitled Vertical Multiple Blade Turbine, which is incorporated herein by reference in its entirety.

The blade cross-section 800 may include a rigid portion A and a relatively flexible portion B. The flexible portion B may be approximately 0.1 to approximately 0.3 the entire length of the portions A and B. Preferably, the flexible portion B may be between approximately one-sixth (⅙^{th}) to approximately one-eighth (⅛^{th}) the total length of the portions A and B, with the rigid portion A being the remainder.

The relatively flexible portion B of the blade cross section 800 may include a flexible, trailing flap 810. The flexible flap 810 may have the proximal portion extending from the rigid portion B while its distal edge is free to move, for example with wind pressure, so that it can change position. The flap 810 may be about one (1) to about four (4) millimeters thick, or approximately paper thin. The flap 810 is sufficient flexible and free to be bendable by hand or by wind pressure. The flap 810 may be angled to redirect moving fluid toward the interior of the turbine. The flap 810 may have smooth interior and exterior surfaces. Alternatively, the flap 810 may have dimples, crevices, or other surface features that create beneficial micro-turbulences. The flap may be a separate item attached to the rigid portion of the blade, or may be an integral portion of the blade.

The blades may be made from a composite material re-enforced with glass fibers. The blades may have a hardness that transitions from rigid, to soft, to very soft moving from the leading edge 806 to the tail of the flap 810. In one embodiment, the blade cross section 800 may be relatively rigid the first two-thirds (⅔^{rd}) of the rigid portion A (shown in FIG. 8) extending from the leading edge. With respect to the durometer scale, the first two-thirds (⅔^{rd}) of the rigid portion A may have approximately seventy (70) to approximately one-hundred (100) durometers of hardness. The hardness may be constant throughout the first two-thirds (⅔^{rd}) of the rigid portion A, or be within a range and decreasing.

The blade cross section 800 may be relatively soft the last one-third (⅓^{rd}) of the rigid portion A, including the trailing edge 808. The last one-third (⅓^{rd}) of the rigid portion A may have approximately thirty-five (35) to approximately fifty-five (55) durometers of hardness. The hardness may be constant throughout the last one-third (⅓^{rd}) of the rigid portion A, or be within a range and decreasing.

The flexible flap 810 may be relatively very soft. The flexible flap 810 may have approximately ten (10) to approximately fifteen (15) durometers of hardness. The hardness may be constant throughout the flap, or be within a range and decreasing.

Alternatively or additionally, the blade cross section 800 may include a variable flexibility and/or density. The flexibility of the blade may be lower or rigid at the leading oval edge 806 and progressively become more and more flexible moving across the cross section 800 toward the trailing edge at the outer edge of the flap 810. Likewise, the density of the blade may be higher at the leading oval edge 806 and progressively become less dense and lighter moving across the cross section 800 toward the trailing edge 808.

The cross-sectional length from the leading edge 806 to the trailing edge 808 may be a function of a blade height. In one embodiment, the maximum cross-sectional length, which is at the mid-height point of the blade, may be approximately the total blade height divided by 6.333. Other cross-sectional dimensions may be used. A preferred cross-sectional design for a specific air foil is illustrated in FIG. 17 and described herein above.

FIG. 21 shows a blade 210 reinforced with a metal cable 220, such as a stainless steel cable that extends from the top to the bottom of the blade. In FIG. 21, the blade 210 curves inwardly at an angle, for example, between twenty-five (25) degrees and fifty-five (55) degrees, to form the inlet section 212 of the blade 210 which may reduce air turbulence at the tips of the blade. The inlet section 212 may be attached to a shock absorber the latter of which is attached to the rotor (See FIG. 16), or the inlet section may be connected directly to the rotor. The cable 220 may be under tension such that the blade 210 benefits from the strength of the reinforcing stainless steel cable 220 shown in FIG. 21. The cable may run the full length of the blade and may be under stress. Ends of the cable 220 and the solid thick ends of the top and bottom distal sections may be attached to the shock absorbers. The shock absorbers may be bolted to the rotor hub, which as shown in FIG. 16 may be bolted to the hub in the in form of a ring or disc 202 that serves to concentrate and direct fluid flow towards the blades 210.

Each blade may incorporate three distinct design components: an airfoil section characterized by a strong aerodynamic generally hollow wing; top and bottom distal sections providing a strong connection to the hub; and a shock absorber section. The top and bottom distal sections may be thick and reinforced with steel and/or reinforced composite materials. Design of the top and bottom distal sections may reduce blade losses of energy.

### VI. Exemplary Generator Hubs

Each generator hub may be held in place longitudinally via a bearing set or other linkages mounted on a central, non-rotating axle. Each hub may have a circular interior cross-sectional area through which the central axle runs through. During operation, each generator hub may rotate around the central, non-rotating axle in unison with the respective rotor blade set.

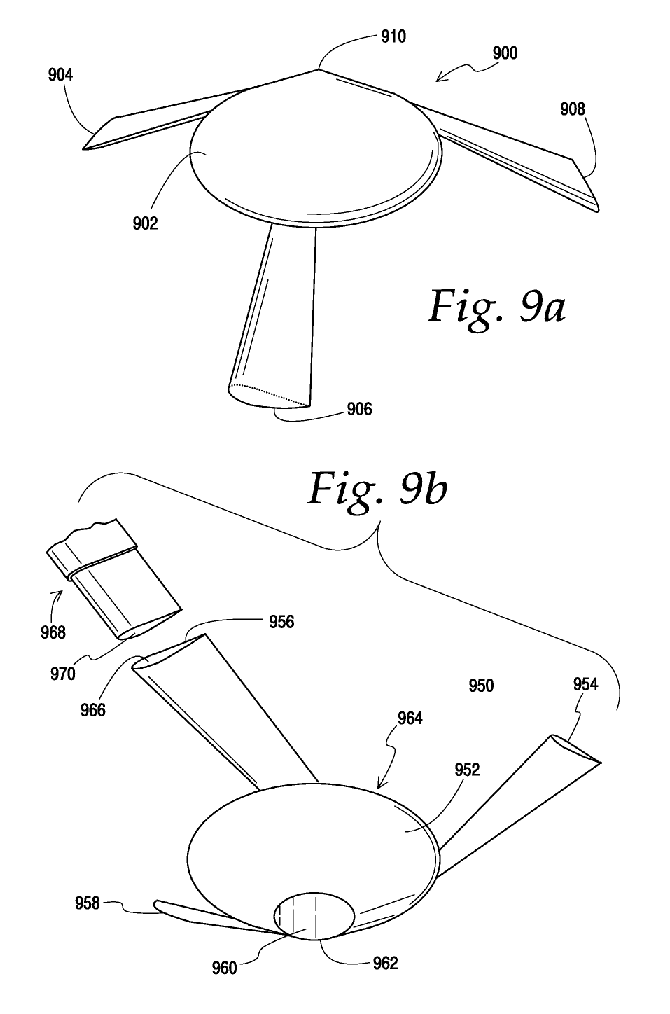

FIG. 9a illustrates an exemplary generator hub 900. The generator hub 900 may include a base 902, a first receptacle arm 904, a second receptacle arm 906, and a third receptacle arm 908. The generator hub 900 may be mounted longitudinally on a central, non-rotating axle (as shown in FIG. 1), such as via a bearing set or via a generator, as shown in FIG. 12. As such the generator hub 900 may be rotatable about the central, non-rotating axle, but fixed in place along the longitudinal axis of the axle. The generator hub 900 may include additional, fewer, or alternate components.

The base 902 may include a bowl-like structure. The base 902 may comprise a housing that extends outwardly from the central, non-rotating axle at an inward angle, such as at a thirty, forty-five, sixty, or acute angle to the axle. The base 902 may be interconnected or integrated with the first receptacle arm 904, the second receptacle arm 906, and the third receptacle arm 908, each arm 904, 906, 908 being spaced equidistant apart. Each arm 904, 906, 908 may be mounted on the exterior or the interior of the base 902. Each arm 904, 906, 908 may have posts or male fittings that snap into corresponding holes or female receptors on the base 902. Other manners of interconnection may be used. Preferably, once arms 904, 906, 908 are attached to the base 902, the exterior and/or other surfaces of the hub 900 remain smooth for aerodynamic purposes.

Each arm 904, 906, 908 may have a concavo-convex hollow interior that the corresponding concavo-convex, cross-sectional areas of each blade may fit into. In other words, the hollow interior of each arm 904, 906, 908 may act as a female member and the end of each blade may act as a male member during assembly. Each end of a blade may fit snuggly or snap into a hollow interior of an arm 904, 906, 908, which may alleviate the need for any mechanical fittings to interconnect each arm 904, 906, 908 to a corresponding end of a blade, which may in turn enhance aerodynamic performance.

The hub 900 shown in FIG. 9a may be positioned on the top of an outer rotor blade set. Thus, the hub 900 may include a cone-like exterior surface that culminates in an apex 910.

FIG. 9b illustrates another exemplary generator hub 950. The hub 950 may include a base 952, a first receptacle arm 954, a second receptacle arm 956, and a third receptacle arm 958. Each arm 954, 956, 958 may be inclined at an acute angle relative to the axis of the hub 950 and arranged an equidistant apart. Each arm 954, 956, 958 may have a receptacle for receiving one end of a blade. The hub 950 may include additional, fewer, or alternate components. For example, the hub 950 may utilize tensioned steel cables extending through the receptacle arms for providing strength.

Each arm 954, 956, 958 may be interconnected or integrated with the base 952. The base 952 may have a cone-like surface that extends from a larger circular surface 964 to a smaller circular surface 962. The base 952 may have a donut-shaped cross-sectional area including a circular interior 960 through which a central, non-rotating axle fits. The central, non-rotating axle may hold the rotor blade set in place longitudinally and axially.

Each arm 956 may have an interior cavity 966. The interior cavity 966 may have concavo-convex cross-section similar to the concavo-convex cross section 970 of the blade ends 968. Each blade end 968 may function as a male end and be inserted into an interior cavity 966 functioning as a female end. The blade end 968 may lock into place. Alternatively, each arm 956 may function as a male end and the blade end 968, or a portion thereof, may function as a female end. Alternate interconnections may be used.

In one embodiment, the top hub configuration may include three top hubs arranged vertically, one above the next. The bottom hub configuration may include three bottom hubs arranged vertically, one above the next. The base of each hub may have a longitudinal length of approximately five (5) inches (along or with respect to the longitudinal axis of the central axle). The larger circular surface of the base of one hub may be positioned approximately six and a half (6½) inches above the larger circular surface of the base of an adjacent hub. In other words, the spacing between the hubs with respect to the axle may be approximately one and a half (½) inches.

The longitudinal distance (along the longitudinal axis of the central axle) from the bottom of the base of the lowest top hub to the top of the base of the highest bottom hub may be approximately eighty (80) inches. The longitudinal distance (along the longitudinal axis of the central axle) from the apex of the highest top hub to the bottom of the lowest bottom hub may be approximately one-hundred sixteen (116) inches.

The receptacle arms of each top hub may have a longitudinal length along the longitudinal axis of the axle of approximately ten (10) inches. The arms of each bottom hub may have a longitudinal length along the longitudinal axis of the axle of approximately ten (10) inches. The longitudinal length of the blades of an outer rotor blade set (along the longitudinal axis of the axle) after being interconnected with the top and bottom hubs may be approximately ninety-six (96) inches. Thus, in one embodiment, the turbine assembly may have approximately nine feet eight inches (one-hundred sixteen inches) of longitudinal length along the longitudinal axis of the axle from the tip of the top hub, running the length of an outer blade, to the bottom of the bottom hub.

### VII. Exemplary Blade Rotation

FIG. 10 shows an exemplary rotational path of an outer rotor blade set 1000. FIG. 10 shows portions of the same blade moving along the longitudinal length of the blade, such as the blade shown in FIG. 5. A first and top cross-sectional blade segment 1002, located approximately six inches from the top end of the outer blade, may have an inner rotational path 1012 (around a central area 1022 of the turbine) having a diameter of approximately twenty (20) inches. Each of the remaining cross-sectional blade segments shown for the outer rotor blade set may be located approximately ten and a half (10½) inches from the next cross-sectional blade segment longitudinally. A second blade segment 1004 may have an inner rotational path 1014 having a diameter of approximately forty-four and a half (44½) inches. A third blade segment 1006 may have an inner rotational path 1016 having a diameter of approximately sixty (60) inches. A fourth blade segment 1008 may have an inner rotational path 1018 having a diameter of approximately sixty-eight (68) inches. A fifth blade segment 1010 may have an inner rotational path 1020 having a diameter of approximately seventy and a half (70½) inches. A sixth and mid-point blade segment 1024 at the longitudinal mid-point of the blade may have a largest inner rotational path 1026 having a diameter of approximately seventy-eight (78) inches. The bottom blade segments continuing from the longitudinal mid-point to the bottom end of the blade may have similar rotational paths of similar size.

FIG. 10 depicts that each blade may be viewed as having a number of slices, or blade segments 1002, 1004, 1006, 1008, 1010, 1024. At each slice, the cross-sectional area of the blade may change. For instance, in one embodiment, the blade may have a cross-sectional area similar to that of airfoil model no. 4412-00-12. Both the chord length and chord height may change and be a function of blade height. The rotation or orientation of the chord may change for each blade slice or segment. For instance, each blade segment may have a different “angle of attack.”

As can be envisioned using FIG. 10, but for a middle rotor blade set instead of an outer rotor blade set, a first and top cross-sectional blade segment may have an inner rotational path around a central area of the turbine having a diameter of approximately eighteen (18) inches. Each of the remaining cross-sectional blade segments shown for the middle rotor blade set may be located approximately nine and a half (9½) inches from the next cross-sectional blade segment longitudinally. A second blade segment may have an inner rotational path having a diameter of approximately thirty-five (35) inches, preferably approximately 34.99 inches. A third blade segment may have an inner rotational path having a diameter of approximately 51.86 inches. A fourth blade segment may have an inner rotational path having a diameter of approximately sixty (60) inches. A fifth blade segment may have an inner rotational path having a diameter of approximately 64.53 inches. A sixth and mid-point blade segment at the longitudinal mid-point of the blade may have a largest inner rotational path having a diameter of approximately sixty-six (66) inches, preferably approximately 66.01 inches. The bottom blade segments continuing from the longitudinal mid-point to the bottom of the blade may have similar rotational paths of similar size.

As can be envisioned using FIG. 10, but for an inner rotor blade set instead of an outer rotor blade set, a first and top cross-sectional blade segment may have an inner rotational path around a central area of the turbine having a diameter of approximately ten (10) inches. Each of the remaining cross-sectional blade segments shown for the inner rotor blade set may be located approximately eight and a half (8½) inches from the next cross-sectional blade segment longitudinally. A second blade segment may have an inner rotational path having a diameter of approximately twenty-eight (28) inches. A third blade segment may have an inner rotational path having a diameter of approximately forty-five (45) inches. A fourth blade segment may have an inner rotational path having a diameter of approximately fifty-three (53) inches. A fifth blade segment may have an inner rotational path having a diameter of approximately 56.72 inches. A sixth and mid-point blade segment at the longitudinal mid-point of the blade may have a largest inner rotational path having a diameter of approximately fifty-eight (58) inches, preferably approximately 58.01 inches. The bottom blade segments continuing from the longitudinal mid-point to the bottom of the blade may have similar rotational paths of similar size.

### VIII. Exemplary Generator Configuration

The turbine may include various generator configurations. The turbine may include (1) one or more stationary stators attached or otherwise affixed to a non-rotating axle, and one or more rotating rotors each attached to or otherwise affixed to an individual rotatable rotor assembly, such as via a generator housing encased within a hub, (2) a reversed configuration, and/or (3) a rotating coil or winding element attached to or otherwise affixed to a first rotatable rotor assembly, and a rotating magnet element attached to a second rotor blade set. The turbine may incorporate asynchronous generators, which may have few moving parts resulting in low wear, long life-cycle. Other configurations may be used.

Each rotor blade set may be attached to a rotating generator and/or a rotating generator element. The rotating generator elements may include magnets and/or copper windings and/or coils. For instance, it may be more aerodynamic to use a coil as a rotating generator element if it weighs less than a desired magnet of heavier material. Each rotating generator element may be located in proximity to a non-rotating generator element, such as a copper winding or magnet, to facilitate power generation. Generators with additional, fewer, or alternate components may be used.

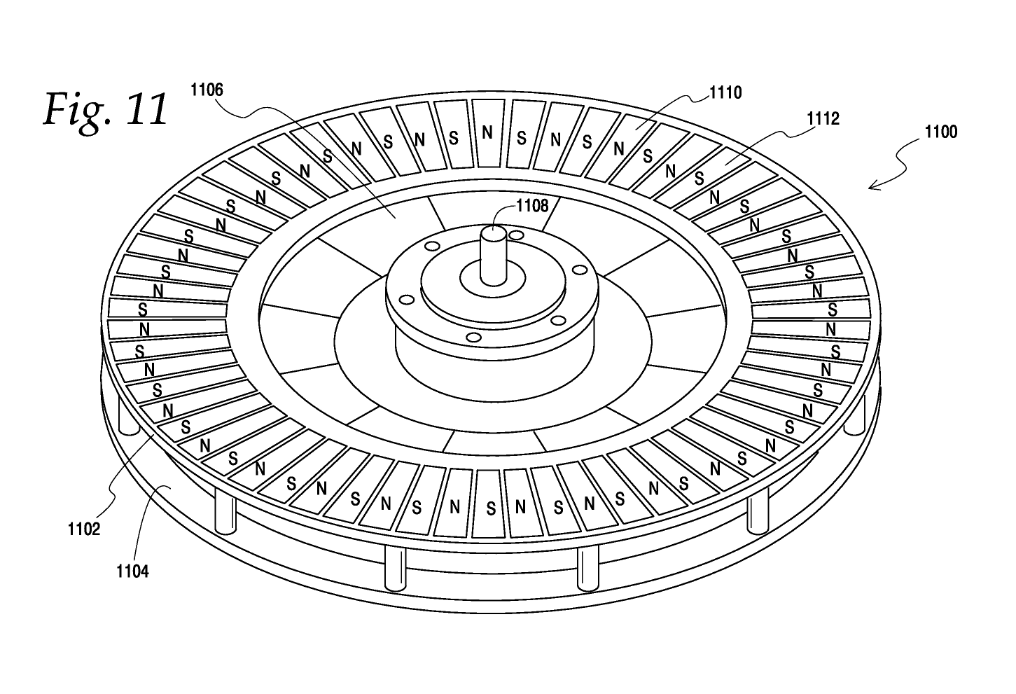

FIG. 11 illustrates an exemplary generator 1100. The generator 1100 may include rotating element(s) 1102, 1104 and a non-rotating element 1106. The generator 1100 may be enclosed, housed within, or otherwise affixed to a generator hub. The generator 1100 may include additional, fewer, or alternate components.

The generator 1100 may have two concentric rings of magnets 1110, 1112 operating as rotating elements 1102, 1104. The rotating elements 1102, 1104 may be affixed to a generator housing. The generator housing may be affixed to the hub in such a manner that the generator housing is interconnected with the blades via the hub. As such, during operation, the rotation of the blades will rotate the hub, and in turn, the rotation of the hub will rotate the generator housing and the rotating generator elements 1102, 1104.

The generator 1100 may have an inner coil operating as a non-rotating element 1106. The non-rotating element 1106 may be affixed or mechanically connected to the central, non-rotating axle 1108 and may not be affixed to the generator housing. As such, the non-rotating element 1106 of the generator 1100 may not rotate about the axle 1108 during operation.

In other words, a typical generator may have a rotating axle that spins a moving rotor element within a non-rotating stator element, which may be enclosed within a stationary housing. On the other hand, the present embodiments disclose a non-rotating axle 1108 that is attached to a non-rotating generator element 1106. A generator housing may be attached to and rotatable about the non-rotating axle 1108, such as via bearings. One or more rotating generator elements 1102, 1104 may be affixed to the generator housing. Affixing the generator housing to the rotatable hubs may permit the rotating elements 1102, 1104 to be spun around the non-rotating axle 1108 and the non-rotating element 1106 as the blades rotate.

In one embodiment, the generator 1100 may have sixty-four magnets 1110, 1112 to facilitate the generation of alternating current at sixty-four hertz. Preferably, the alternating current is generated between approximately sixty-two and approximately sixty-five hertz. Modular electronics and PLC control may be used to condition and merge the current signals from each generator into a single power signal. Alternatively, each generator may provide an individually usable power signal.

Other generator configurations may be used, including those with additional, fewer, or alternate components. For instance, a conventional pancake generator configuration may be used, such as the one disclosed in U.S. Pat. No. 5,117,141, which is incorporated herein by reference in its entirety.

IX. Rotors with Interconnected Blades and Generators

The turbine design may include a uni-body structure for the blades that may not require an external frame or an internal strut. Instead of requiring any internal structure, the turbine design may utilize a sandwich effect during rotation that evenly distributes force and stress.

The rotatable rotor assemblies may incorporate generator hubs and/or generators on the top and/or bottom of the blades. The blades may provide air movement and cooling effect for the generators. Each hub may encase and provide weather protection for the generator, and eliminate the need for a rotating shaft.

Incorporating the generators into the rotatable rotor assemblies, via the hubs, may provide significant mechanical benefits. A free wheel effect may result, leading to reduced stress and minimized fluctuations in rotational speed. By interconnecting rotating generator elements with the rotor blade sets, one or more associated bearing sets may be eliminated (i.e., bearing sets may be replaced by air gaps existing between the rotating generator elements and a central, non-rotating axle), increasing mechanical efficiency and allowing for substantially frictionless rotation of the blades.

Using two or more generators for each rotor blade set may increase power production, although a single generator and/or various other combinations of rotating and/or non-rotating generator elements may be used. For example, a first generator hub associated with a first rotor blade set may include a rotating generator element and a second generator hub associated with a second rotor blade set may include a non-rotating generator element, or vice versa.

FIG. 12 shows an exemplary generator hub configuration 1200. The hubs shown have an alternate and more rounded shape as compared to those of FIGS. 1 and 9. A first rotatable generator 1202, a second rotatable generator 1204, and a third rotatable generator 1206 may be attached to and supported by the non-rotating axle 1214. Each rotatable generator 1202, 1204, 1206 may be rotatable about the axle 1214, such as via bearings.

The first rotatable generator 1202 may be enclosed within and affixed to a first rotatable hub 1208. The second rotatable generator 1204 may be enclosed within and affixed to a second rotatable hub 1210. The third rotatable generator 1206 may be enclosed within and affixed to a third rotatable hub 1212. The hub configuration 1200 may include additional, fewer, or alternate components.

Each hub 1208, 1210, 1212 may include a shell-like exterior of a first material with an interior cavity. Each respective generator 1202, 1204, 1206 may fit within the cavity. The cavity between each hub 1208, 1210, 1212 and respective generator 1202, 1204, 1206 may be filled with a second filler material or rubber molding that sticks to the surface of both the hubs and the generators. The second material may be of sufficient strength, elasticity, resiliency, and/or durability to permit the rotatable hub 1208, 1210, 1212 shell-like exteriors to drag the respective rotatable generators 1202, 1204, 1206 about the axle 1214 during operation. The filler material may be pre-molded in one or more pieces, such as a top and a bottom interlocking pieces that may encase a generator.

Each hub 1208, 1210, 1212 may be interconnected with a respective set of blades as discussed herein and may be rotatable about the non-rotatable axle 1214. As each hub 1208, 1210, 1212 rotates about the axle 1214, the respective generator casings 1202, 1204, 1206 may rotate as well, along with the respective rotating generator elements of each generator, generating power.

In one embodiment, the three sets of hubs 1208, 1210, 1212 may be assembled as a single assembly and shipped to customers as part of a kit. During in plant assembly, a bottom hub 1212 may be positioned on an axle 1214. A rotating generator element may be slid onto the axle 1214 and into the interior portion of the hub 1212, and rotatably affixed to the axle 1214. A non-rotating generator element may be slid onto the axle 1214 and into the interior portion of the hub 1212, and non-rotatably affixed to the axle 1214. A bonding material, such as glue, may be used to affix the rotating generator element to the hub 1212, for rotation of the generator element with the blades. After which, the hub 1212 may be sealed, such as via an o-ring material, encasing the generator elements inside the hub 1212.

The next hubs 1210, 1208 may be assembled similarly. There may be air gaps between rotatable parts and the hubs 1206, 1208, 1210. The hub configuration 1200 may be shipped and attached to a base or a flexible base on-site.

### X. Exemplary Transmission

The turbine may improve power generation in relation to moving fluid speed by switching in more magnetic coils as turbine speed increases. With this type of configuration, a mechanical transmission may not be necessary. Rather, performance may be enhanced by activating more or less magnetic coils, such as by a processor controlling the application of current to one or more generator elements. Processor control may facilitate smoother operation over an increased range of moving fluid speeds by being responsive to sudden gusts and lulls.

Alternatively, the turbine may include an integrated blade-generator-transmission configuration to minimize mechanical efficiency drain. The turbine may include a transmission capable of handling turbine torque levels that mechanically may produce up to approximately a four-hundred percent (400%) ratio range, with rapid shifting over a number of gear ratios. A continuously variable transmission may enhance the ability to capture gusts and vary rotor speed to optimize speed ratio.

In one embodiment, the turbine may include an optional dedicated transmission for each rotor blade set that may be housed in the generator hub. NuVinci® transmission technology being developed by Fallbrook Technologies, Inc. may be used, such as that disclosed in U.S. Pat. No. 7,063,640, which is incorporated herein by reference in its entirety. Transmissions with additional, fewer, or alternative components may be used.

In another embodiment, the turbine rotors may be provided on their circumferences with gear racks to rotate pinion gears for driving generators, or gear trans for driving a generator. As illustrated in FIGS. 19 and 20, the rotor in the form of a ring or disc 310 that has external gear rack or teeth 311 attached. The rotor is rotated by blades 301. The external gear teeth 311 may be on a belt that is engaged by a pinion 320 connected to the shaft of the generator 330. Although the FIG. 19 embodiment shows only one generator 330, it should be understood that more than one generator may be mounted to be driven the same gear rack 302 around the circumference of the disc 300. The gear ratio of the gear rack to the pinion may be high, thereby providing high speed rotation of the pinion 320 and generator 320.

### XI. Integrated Computerized Control

The turbine may use programmable logic control (“PLC”) and/or computer programming of the generator(s) to optimize performance. Computer control may facilitate the operation of the generators over a full range of moving fluid speeds. Energy may be supplied over various ranges, such as in the range of approximately 0.5 kW to approximately 5 kW.

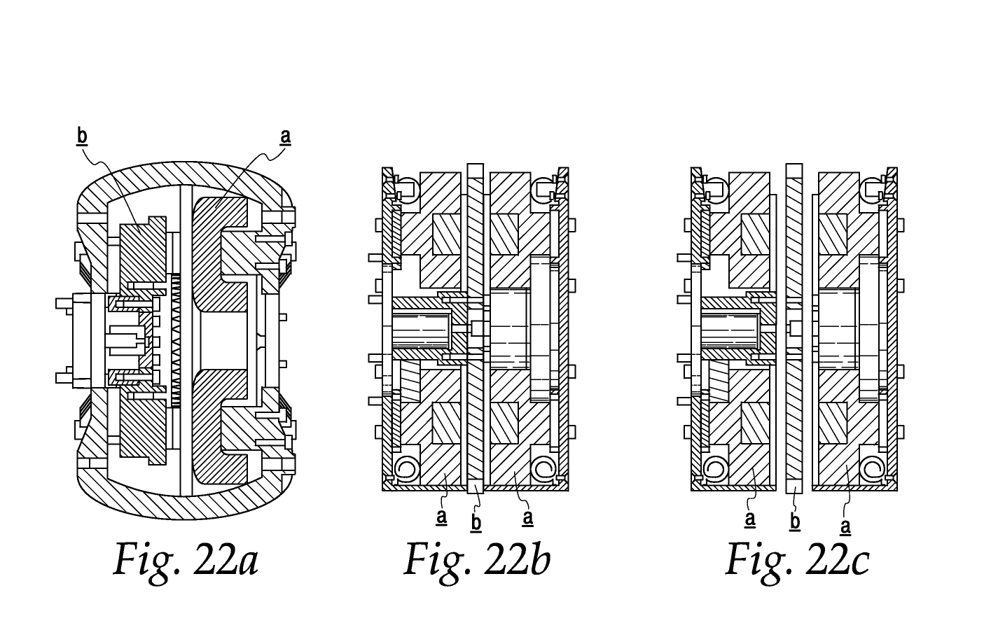

A processing unit may independently control the rotor blade sets, such as via a precision positioning electric motor system. Additionally, the turbine may include an axial flux generator with a dynamically adjustable air gap, such as shown in FIG. 22. FIGS. 22 a, b, and c show exemplary single and dual stator configurations. The stators are indicated by a and the rotor by b. The right side of FIG. 22 shows a dual stator configuration having an adjustable air gap between the stators and a rotor. Changing the air gap may change the electromagnetic field of the generator, and thus affect power generation.

A processor may regulate the air gap according to fluid flow conditions. Changing moving fluid speeds may drive the turbine blades with different torque. The control logic may change the width of the air gap to account for the difference in torque being applied to the blades, such as forcing a smaller gap in fast fluid conditions. Alternatively, the processing unit may alter the electromagnetic field of the generator by switching on or off one or more magnets, and/or altering the amount of current being applied to one or more magnets or other generator elements.

If the turbine is equipped with one or more transmissions, the processing unit may control a transmission gear ratio of each transmission and/or vary the transmission shaft output with varying load. The transmission gear ratio may be changed in relation to fluid flow conditions, which may affect the amount of force acting on the generator. In one embodiment, a continuously variable planetary (CVP) drive train may be incorporated to maintain blade speed stable and consistent.

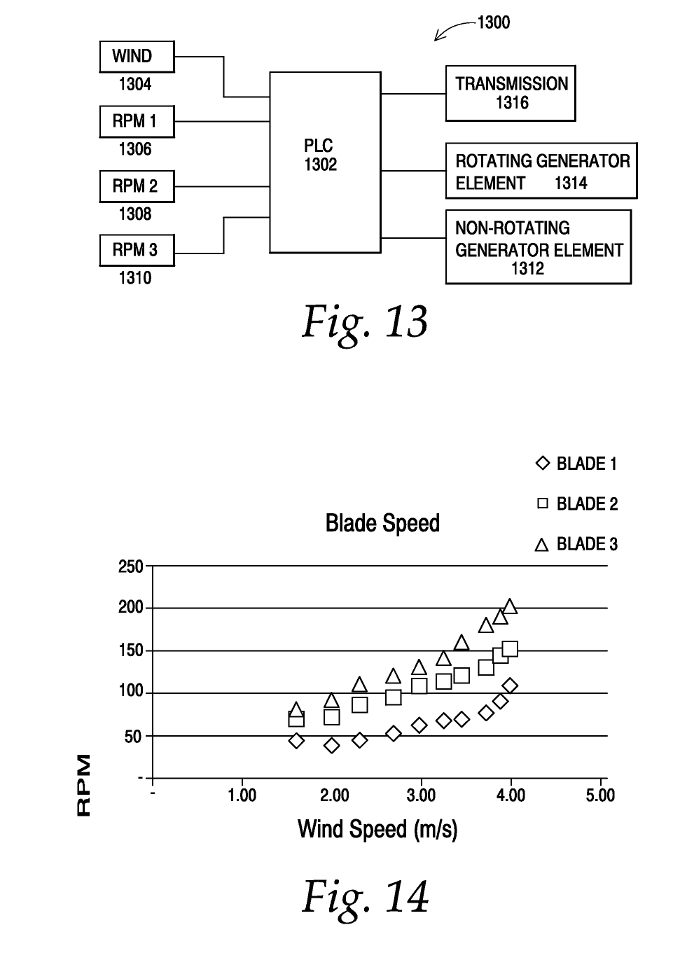

FIG. 13 illustrates an exemplary computerized control system 1300 for the turbine. The control system 1300 may include a processing unit 1302 with embedded programmable logic control. The processing unit 1302 may receive signals from various sensors. The processing unit 1302 may receive signals representing moving fluid speed 1304 from a moving fluid speed sensor. Each rotor blade set may include a revolution sensor 1306, 1308, 1310, such as a light sensor. The processing unit 1302 may receive signals from each sensor 1306, 1308, 1310 indicating the rotations per minute (RPM) of each rotor blade set.

Each rotor blade set may include a generator that includes non-rotating and/or rotating elements. The non-rotating generator elements 1312 may include stators, coils, and/or other components, and the rotating generator elements 1314 may include rotors, permanent magnets, and/or other components—or vice versa. The processor unit 1302 may send and receive signals to the non-rotating generator elements 1312 and/or rotating generator elements 1314. The processor unit 1302 may send signals that alter the air gap between rotating and non-rotating elements 1312, 1314, and/or the amount of current being applied to various generator elements 1312, 1314.

Each of the rotor blade sets may include a dedicated transmission 1316. A transmission dedicated to a rotor blade set may be enclosed in the corresponding generator hub, along with the rotating and non-rotating generator elements 1312, 1314. The processor unit 1302 may send and receive signals to the dedicated transmissions 1316. The processor unit 1302 may cause each dedicated transmission 1316 to shift to an appropriate gear based on current moving fluid speed 1304 and/or respective rotor blade set rpm 1306, 1308, 1310.

In one embodiment, SEMA (“Segmented ElectroMagnetic Array”) technology may be used that includes permanent magnet electric motors and controllers, which is being developed by Kinetic Art & Technology Corp. and commercialized by Lynx Motion Technology Corp. SEMA generators may be operated at constant or variable speed, steady state or intermittently, and may be reversed. Since there is no cogging, even at low speeds, power is delivered continuously. A computer may control the torque, speed, and position of the generator elements. As an example, the present embodiments may incorporate a segmented coil array and two adjacent magnetic rotors, as disclosed by U.S. Patent RE 38,939, which is incorporated herein by reference in its entirety. In one embodiment, the generators may be Lynx Model No. E813.

### XII. Exemplary Smart Blades

The blade shape and composition may allow the blades to be “smart blades” that bend and stress at elevated wind speeds, improving efficiency of rotation. The blades may be made using composite manufacturing technology and/or from a mix of materials, such as foam, fiberglass, and polymers. The blades may flex or bend as different gravitational and rotational stresses occur and the speed of moving fluid changes. As flow increases, the flex and bend of the blade may conform to a more aerodynamic shape.

The blades may be manufactured from a molding, coating, and powder impregnation process. Each blade may comprise a foam core made via a molding or other process. Other cores may be used, including wood cores. The foam core may be coated with reinforcing fibers to add strength, such as fiberglass, glass, carbon, or other coatings.

An external skin of thermoplastic polymers may then be added to protect the reinforcing fibers from the external environment, maintain the position and orientation of the reinforcing fibers, and provide further shape for the blade. Exemplary thermoplastic polymers may include polypropylenes, nylons, engineering plastics, PPS-poly (phenylene sulphide), PEEK-poly (ether ether ketone), or other thermoplastics.

The reinforcing fibers and/or thermoplastic skin may be applied to the core in a manner to create a surface morphology that may generate micro-turbulences. Tiny imperfections in the blade surface may then be alleviated using a powder impregnation process. Fibers may be positioned under computerized precision in any direction, such as along the vertical, horizontal, and diagonal axis and/or curved surfaces of the blade. After which, a polymer may be added to obtain the desired strength, flexibility, stiffness, elasticity, and/or density.

In one embodiment, the blades may be manufactured using so-called “5D” composite technology being developed by Andrew Rekret, and/or the manufacturing methods and techniques disclosed in U.S. Pub. No. 2007/0013096, entitled “Multistage method and apparatus for continuously forming a composite article,” U.S. provisional application No. 60/699,465, entitled “Method of Pultruding Foam Reinforced Panel,” and international application no. PCT/CA2006/001111, entitled “Multistage Method and Apparatus for Continuously Forming a Composite Article,” which are all incorporated herein by reference in their entireties.

### XIII. Exemplary Blade Surface Morphology

The blades may have a non-proportional profile between the leading and trailing edges. The shape of a blade may change in relation to the amount of material that is supported by the blade. Additionally, the shape of the blade may change during each rotation depending on gravitational factors and the rate of rotation. The structural strength of each blade may overcome flat-wise bending stresses.

The blades may be shaped to counterbalance forces. The blades may enhance lift and reduce drag, which may allow the blade to turn with sharper angles and at a higher speed than traditional blade designs. The flow of fluid may move close to the blade surface. As a result, controllable fluid flow may be produced.

The amount of drag may be changed by altering the boundary layer. The blade design may include shapes, slits, and slots to create turbulence. For example, a surface morphology that includes dimples may be used. The micro-turbulence created by dimples, similar to those of a golf ball, may result in greater lift and reduced drag. Turbulence may help the flow remain attached to the surface of the blade and reduce the size of the separated wake so that by reducing the drag, faster and “easier” movement of the blades may be generated.

The blades may have one to three different textured surfaces: the leading edge, rigid section; the flexible flap portion with a self adjusting trailing edge. The leading and trailing flap portion may be formed with protruding and recessed that may the air flow less turbulent. The leading edge may have a comb-like structure to break down turbulence and thus reduce noise. The flap portion may be provided with serrations on the distal or trailing edge to reduce noise. The rigid section may have a feathered surface. The foregoing design properties are inspired by the design of bird wings.

The shape of each blade may be mathematically calculated to approximate techniques used to build multi-radii objects turning on an average degree of curvature.

In one embodiment, the blades may have a surface morphology replicating owl feathers. The blades may include a leading edge, similar to an owl's serration feathers. The flow pattern breaking edges may generate small vortexes in the fluid flow that break up larger vortexes, and reduce or eliminate associated noise.

The cross-sectional density differential of each blade may also have avian characteristics. A manufacturing technique may be used that positions more glass, resin, or other fibers at specific sections of the blade to exactly mimic the density ratio pattern of an owl's wing. The method of manufacture may include the ability to change the density of the composite blade material such that at least a portion of each blade may be configured to have a velvety surface feel and density similar to that of the wing of an owl. Each blade may act differently depending on the number, size, depth, width, shape and configuration of the feather imprint.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

1. A turbine operated by moving fluids, comprising:
a first rotatable rotor assembly having a central portion, at least one rotatable first hub on at least one side of said central portion of said first rotatable rotor assembly, and a first set of blades extending from said at least one first hub and rotatable in a first rotational path;
said first rotatable rotor assembly so constructed and arranged for rotation by said first set of blades;
a second rotatable rotor assembly inside said first rotatable rotor assembly having at least one second rotatable hub on at least one side of the central portion, and a second set of blades extending from said at least one second hub;
said second rotatable rotor assembly so constructed and arranged for rotation of said second set of blades in a second rotational path within and sufficiently close to the first rotational path of said first set of blades that fluid action between said first set of blades and said second set of blades at least partially aids the rotation of said second rotatable rotor assembly; and
at least one electrical generator operated by one or more of said first and second rotatable rotor assembly.

2. The turbine of claim 1 in which said second rotatable rotor assembly is so constructed and arranged for rotation of said second set of blades in a second rotational path within and sufficiently close to the first rotational path of said first set of blades that the fluid action between said first set of blades and said second set of blades rotates said second rotatable rotor assembly faster than said first rotatable rotor assembly.

3. The turbine of claim 1 in which one or more of said at least one generator has at least one electrical coil and at least one magnet moveable relative to each other by one or more of said first and second rotatable rotor assembly.

4. The turbine of claim 1 in which said at least one generator has at least one moveable part located on the rotatable hub of and rotated by one or more of said first and second rotatable rotor assembly.

5. The turbine of claim 1 in which said at least one generator has at least one rotatable magnet, and at least one stator coil is located in proximity to said at least one rotatable magnet.

6. The turbine of claim 1 in which said each said at least one electrical generator has at least one rotatable electrical coil driven by one or more of said first and second rotatable rotor assembly.

7. The turbine of claim 1 in which one or more of said at least one electrical generator has at least one rotatable electrical coil driven by one or more of said first and second rotatable rotor assembly, and at least one stator magnet located in proximity to said at least one rotatable electrical coil.

8. A wind turbine having a reduced amount of noise, comprising:
a plurality of blades each having a length and an overall width, said blade lengths longer than said blade widths;
said blades having leading edges;
said blades having rigid portions including and adjacent to said leading edges;
relatively flexible flaps having proximal and distal portions relative to the rigid portion of the blades;
said proximal portions of said relatively flexible flaps extending from to said rigid portions of said blades; and
said relatively flexible flaps being sufficiently flexible and free to move and change position with wind pressure.

9. The wind turbine of claim 8 in which said rigid portions of said blades comprises a composition of plastic reinforced with fibers.

10. The wind turbine of claim 8 in which the widths of said flexible flaps are from about 0.16 to about 0.12 times the widths of the rigid portions of said blades.

11. The wind turbine of claim 8 in which said rigid portions of said blades comprise a lead portion having a hardness between approximately 70 and approximately 100 durometers, and the portion of the blade adjacent to said lead portion has a hardness of between approximately 35 and approximately 55 durometers.

12. The wind turbine of claim 8 in which said flexible flaps have a hardness of between approximately 10 and approximately 15 durometers.

13. A rotatable rotor assembly for a wind turbine which is adapted to be packaged with disassembled parts and later assembled, comprising:
at least one pair of hubs having a central axis;
a plurality of receptacles on said hubs at acute angles relative to the axes of the hubs and arranged equidistant apart;
a plurality of blades having end portions; and
said receptacles formed with cavities for receiving the end portions of the blades.

14. A turbine operated by moving fluids, comprising:
a non-rotatable post;
a first rotatable rotor assembly having at least one first hub rotatably mounted on said non-rotatable post and a first set of blades connected to said at least one first hub;
said first rotatable rotor assembly constructed and arranged for rotation of said first set of blades in a first rotational path;
a second rotatable rotor assembly inside said first rotatable rotor assembly having at least one second hub rotatably mounted on said non-rotatable post, and a second set of blades connected to said at least one second hub;
said second rotatable rotor assembly so constructed and arranged for rotation of said second set of blades in a second rotational path within and sufficiently close to the first rotational path of said first set of blades that fluid action between said first set of blades and said second set of blades at least partially aids the rotation of said second rotatable rotor assembly; and
at least one electrical generator operated by one or more of said first and second rotatable rotor assembly.

15. The turbine of claim 14 in which one or more of said at least one generator has at least one electrical coil and at least one magnet moveable relative to each other by one or more of said first and second rotatable rotor assembly.

16. The turbine of claim 14 in which said at least one generator has at least one moveable part located on the rotatable hub of and rotated by one or more of said first and second rotatable rotor assembly.

17. The turbine of claim 14 in which said at least one generator has at least one rotatable magnet, and at least one stator coil is located in proximity to said at least one rotatable magnet.

18. The turbine of claim 14 in which said each said at least one electrical generator has at least one rotatable electrical coil driven by one or more of said first and second rotatable rotor assembly.

19. The turbine of claim 14 in which one or more of said at least one electrical generator has at least one rotatable electrical coil driven by one or more of said first and second rotatable rotor assembly, and at least one stator magnet located in proximity to said at least one rotatable electrical coil.

20. A turbine operated by moving fluids, comprising:
a non-rotatable post;
at least one rotatable rotor assembly having at least one hub rotatably mounted for rotation on said non-rotatable post;
at least one set of blades connected to said at least one hub for rotating said rotor assembly;
said rotatable rotor assembly so constructed and arranged for rotation by said at least one set of blades in a rotational path about said non-rotatable post;
at least one electrical generator operated by one or more of said at least rotatable rotor assembly; and
said non-rotatable post supported by a flexible support constructed and arranged to maintain said non-rotatable post substantially in a substantially vertical position absent any wind pressure and inclined from vertical position when said blades are under wind forces.

21. The turbine of claim 20 in which said non-rotatable post has a variable axis flexible support constructed and arranged whereby the non-rotatable post may be inclined by wind speeds above predetermined amounts.

22. A turbine operated by a moving fluid comprising:
at least two hub members mounted for rotation about a center axis;
at least two blade sets each comprising a plurality of blades each of which extends generally parallel to said center axis and is spaced at the same radial distance from said center axis as each of the other blades and is equally spaced circumferentially from the other blades, and is constructed and arranged to rotate said hub member about said center axis;
said at least two blade sets being spaced apart radially from each other for rotation in separate paths from each other; and
said blades of each said blade sets having a different chord length from the chord length of the other blade set, and said chord length of the blades of the outer blade set being longer than the chord length of the inner blade set.

23. The turbine of claim 22 in which said blades of said at least one blade set have an airfoil design, including a leading edge, a trailing edge, inner camber, and outer camber; said outer camber being longer than said inner camber.

24. A turbine operated by moving fluids, comprising:
a first rotatable rotor assembly having at least one rotatable first hub and a first set of blades extending from said at least one first hub and rotatable in a first rotational path;
said first set of blades each having an airfoil configuration with a first chord length;
said first rotatable rotor assembly so constructed and arranged for rotation by said first set of blades;
a second rotatable rotor assembly inside said first rotatable rotor assembly having at least one second rotatable hub and a second set of blades extending from said at least one second hub;
said second set of blades each having an airfoil configuration with a second chord length shorter than said first chord length;
said second rotatable rotor assembly so constructed and arranged for rotation by said second set of blades in a second rotational path within and sufficiently close to the first rotational path of said first set of blades that fluid action between said first set of blades and said second set of blades at least partially aids the rotation of said second rotatable rotor assembly; and
at least one electrical generator operated by one or more of said first and second rotatable rotor assembly.

25. The turbine of claim 24 in which said second rotatable rotor assembly is so constructed and arranged for rotation of said second set of blades in a second rotational path within and sufficiently close to the first rotational path of said first set of blades that the fluid action between said first set of blades and said second set of blades at least partially aids the rotation of said second rotatable rotor assembly faster than said first rotatable rotor assembly.
